(19) United States
(12) Patent Application Publication
(10) Pub. No.: US 2004/0170181 A1
(43) Pub. Date: Sep. 2, 2004

(54) Prioritized alternate port routing

(75) Inventors: Christopher J. Bogdon, Cranberry Township, PA (US); Christian E. Hofstaedter, Perkasie, PA (US)

Correspondence Address: GREENBLUM & BERNSTEIN, P.L.C., 1950 ROLAND CLARKE PLACE, RESTON, VA, 20191, US

(73) Assignee: Padcom, Inc., Bethlehem, PA (US)

(21) Appl. No.: 10/374,070

(22) Filed: Feb. 27, 2003

(51) Int. Cl. H04L 12/28

(52) U.S. Cl. 370/400; 370/395.42

(57) ABSTRACT

Data for an application is routed over a highest priority, available network from multiple networks that are assigned application-specific routing priorities. Data of the application is received and the highest priority network for the application is determined based on the application-specific routing priorities. The received data is sent over the highest priority network when the highest priority network is available. When the highest priority network is unavailable, a next highest priority network is determined based on the assigned application-specific priorities for the application. The data is sent over the next highest priority network when the highest priority network is unavailable and the next highest priority network is available.

### CROSS REFERENCE TO RELATED APPLICATIONS

The present application is related to U.S. patent application Ser. No. 10/084,049, filed on Feb. 28, 2002, entitled “Port Routing Functionality”, which is a Continuation-In-Part of U.S. patent application Ser. No. 09/652,009, filed on Aug. 31, 2000, entitled “Method and Apparatus for Routing Data Over Multiple Wireless Networks”, the contents of which are expressly incorporated by reference herein in their entireties.

The present application is also related to U.S. Pat. No. 6,198,920, filed on Mar. 16, 2000, entitled “Apparatus and Method for Intelligent Routing of Data Between a Remote Device and a Host System,” which is a continuation of U.S. patent application Ser. No. 08/932,532, filed on Sep. 17, 1997, entitled “Apparatus and Method for Intelligent Routing of Data between a Remote Device and a Host System,” which is a continuation-in-part of U.S. Pat. No. 5,717,737, issued on Apr. 14, 1997, entitled “Apparatus and Method for Transparent Wireless Communication Between a Remote Device and a Host System,” the contents of which are expressly incorporated by reference herein in their entireties.

### BACKGROUND OF THE INVENTION

1. Field of the Invention

The present invention relates to the field of wireless communications in general, and more specifically to communications over multiple wireless networks. In particular, the present invention relates to prioritized alternate port routing that provides system administrators of wireless networks with flexibility to designate more specific routing behavior over multiple wireless networks for their applications.

2. Background Information

Currently, the wireless mobile routing system disclosed in U.S. patent application Ser. No. 09/652,009, relies on the concept of a single “default route” associated with each mobile client and host network server. This default route is derived through a combination of network priority and network availability. The highest priority, available network becomes the transport network over which all communications are routed through to the host network server.

The system disclosed in U.S. patent application Ser. No. 09/652,009 was not designed so that the host network server knows the status of other non-default networks for each mobile router. In other words, the host network server only knows the status of the current default network. As a result, the system administrator's ability to specify the behavior of routing for applications is minimal. One method to enhance the IP routing flexibility or granularity of the aforementioned wireless mobile routing system is through a concept called port routing.

The mobile routing system disclosed in U.S. patent application Ser. No. 10/084,049, provides the system administrator with an ability to specify more detailed routing behavior by introducing the concept of additional routes called an “Ignore” route and an “Alternate” route. System administrators are able to specify routing behavior for specific applications over multiple wireless networks.

The administrator of the mobile routing system provided in U.S. patent application Ser. No. 10/084,049 can create an “Ignore” port routing rule for a specific application that is not allowed to communicate over any wireless network. With the “Ignore” port routing rule, the mobile routing system determines if a received packet matches specified criteria. The mobile routing system can ignore and/or discard a packet that matches the criteria set forth in the “Ignore” routing rule.

The administrator of the mobile routing system provided in U.S. patent application Ser. No. 10/084,049 can also create an “Alternate” port routing rule for a specific application that is not allowed to communicate over the current default route. With the “Alternate” port routing rule, the mobile routing system determines if a received packet matches specified criteria. The mobile routing system can route a packet to the network specified by the “Alternate” port routing rule when the packet matches the criteria set forth in the “Alternate” port routing rule. However, if the specified “Alternate” route is not available, another alternate port route was not provided. Additionally, the administrator of the mobile routing system disclosed in U.S. patent application Ser. No. 10/084,049 is not provided with an ability to specify application-specific prioritized alternate port routing for multiple alternate routes.

Accordingly, there currently exists a need to provide a wireless mobile routing system with even greater flexibility or granularity in the ability to specify Internet protocol (IP) routing behavior. One method to enhance the IP routing flexibility or granularity of the aforementioned wireless mobile routing system is through a concept called prioritized alternate port routing.

The function of IP ports is an important part of IP communications. It is well understood that each computer on an IP network will have a unique IP address. Therefore, when one computer needs to send data to another computer, it will address the other computer using the other computer's IP address. Data is not sent between computers, however; data is sent between programs running on those computers. Because computers run multiple programs simultaneously, and those programs may all be communicating over the network, the computer determines which data is for which program using IP ports.

The founding committee for the Internet specified that each application on a computer must send and receive data through a unique port number. In most cases, any time data is sent or received by a computer it will use both the sending and receiving IP address as well as the sending and receiving IP port number. As a result, whenever data is received at a computer, the computer knows which application is supposed to receive the data by looking at the destination port number on the actual packet.

Most standard applications have registered their ports with the Internet Assigned Number Authority (http://www.iana.org/). A sample of those applications with port numbers include: web browsing, port 80; secure web browsing, port 8080; TELNET, port 23; etc. It is an important fact to note that every application that sends and receives data does so on a unique port number. No two applications share the same port number.

The relationship between ports and IP addresses is similar to the relationship between post offices and post office boxes. A United States post office contains many post office boxes. When mail is sent, it is not enough to specify the post office's zip code; the post office box must also be specified. Similarly, when an application wants to send a data packet to another application, it is not enough to merely specify the IP address; the application must also specify the port.

Port numbers are used in a variety of networking applications such as firewalls or proxy servers. If a system administrator wishes to restrict access to a certain application, then the system administrator will do so by restricting data using certain port numbers from being sent through a firewall. However, port numbers have not been used when prioritizing appropriate wireless networks for transmission. Additionally, while the “Ignore”, “Alternate” and “Default” port routing rules of U.S. patent application Ser. No. 10/084,049 can be specified for specific IP addresses or all IP addresses, an ability to specify multiple IP addresses has not been provided without specifying a rule for all IP addresses maintained by the system administrator.

Thus, it would be desirable to provide system administrators of the wireless mobile routing systems with the ability to specify prioritized alternate port routing at a granularity that includes at least the protocol, IP address or multiple IP addresses, port number, and the specific network over which any packet matching the IP address, protocol and port number should be routed according to the specified prioritization.

### SUMMARY OF THE INVENTION

In view of the foregoing, the present invention enhances the port routing functionality of the wireless mobile routing system disclosed in U.S. patent application Ser. No. 10/084,049, filed Feb. 28, 2002. The present invention, which may be embodied as mobile routing software, hardware, or a combination thereof, allows the wireless mobile routing system administrator to specify prioritized alternate routes. Therefore, when an alternate route is configured by the system administrator for an application, the prioritized alternate port routing functionality allows the administrator to specify multiple alternate networks and the order of the alternate networks that should be used for routing packets. The present invention allows the host network server to be aware of the availability of all the networks connected to each wireless client having mobile router functionality. Moreover, the host network server will know when the mobile router has shut down and no networks are available. Furthermore, the network server will be better able to track the status of each wireless client and each wireless network.

With prioritized alternate port routing, the mobile router will not only simply notify the host network server of changes to the default network, the mobile router will also notify the host network server whenever any network becomes available (or unavailable). This will allow both the host network server and the mobile router to route packets over alternate, non-default networks according to the specified priorities. The mobile routers will also be able to continue to route packets over the default network when appropriate.

An example use of the port routing disclosed in U.S. patent application Ser. No. 10/084,049 includes a configuration that allows e-mail applications to communicate only when a spread spectrum network is in coverage, while disallowing any use of web browsers over any network, and routing all computer aided dispatching (CAD) system traffic over any network.

An example use of the prioritized alternate port routing functionality includes a configuration that allows a mobile computer to communicate using multiple networks. A configuration can be used to allow email applications to function over only a first network. The configuration can be used to specify that a computer aided dispatching (CAD) application is routed over a second network. The configuration can be used to specify that, if the second network is not available for the computer aided dispatching application, the computer aided dispatching application is routed over a third network. The configuration can also be used to specify that traffic for an application is never routed over a particular network.

An embodiment of the present invention provides a port routing table that includes eight types of fields. The port routing table may be actually located on both the Host Network Server and the Mobile Router. This allows for the fact that bidirectional communications can occur (i.e., the host can send packets to mobile routers or the mobile routers can send packets inbound to the hosts.) The fields enable an administrator to define the criteria to match different types of packets that flow through the mobile router, as well as the action that the mobile router should take with those packets. The eight types of fields are:

The Type field identifies the type of route entry. In one embodiment, it contains either an “Ignore”, “Alternate” or “Default” keyword. The Type field indicates the action the mobile router should take for the designated packet.

The IP Address field specifies the IP address of the packet received from the route server. It can represent “All” IP addresses, or a specific IP address. If a specific IP address is entered, the user has the choice of specifying if the IP address appears in either the source or the destination address fields within the IP header.

The Netmask field specifies a range of IP addresses within a single definition. The IP address of the packet received from the route server may be specified in a range of one or more IP addresses. The user has the choice of specifying if the IP addresses in the range appear in either the source or the destination address fields within the IP header.

The Protocol Type field identifies what type of transport level protocol the packet is. The values for this field will currently be only TCP, UDP or either. Of course, as additional protocols are employed, the additional protocols can be entered into the Protocol Type field.

The Port Number field identifies the port number of the packet received from the route server. Ports are associated with individual IP applications. The user can specify all ports, or may specify an individual port. The user also has the choice of specifying if the port number appears in the source or destination location in the TCP or UDP header.

The Network ID field is used in conjunction with the Type field. If the user created an “Alternate” entry as specified by the Type field, then the Network ID field can identify which network will be used to route the packets that match the specified criteria. The packets are routed over the network specified by the Network ID field. If the user uses prioritized alternate port routing functionality, the Network ID field can include multiple Network ID values defining which alternate networks can be used to route packets that match the criteria set forth by the port routing entry.

The Port Number Source/Destination field is used to specify a location of the port number as the source, the destination, or either the source or destination of a packet. The user can create an entry that applies only when the port number appears in the source address, only when the port number appears in the destination address, or when the port number appears in either of the source or the destination address of the packet.

The IP Address Source/Destination field is used to specify a location of the IP address as the source, the destination, or either the source or destination of a packet. The user can create an entry that applies only when the IP Address appears in the source address, only when the IP address appears in the destination address, or when the IP Address appears in either of the source or the destination address of the packet.

By taking advantage of the above fields, the administrator has the flexibility to specify that certain applications will use the default routing, certain applications will only function over specified alternate networks, and certain applications will not have their data routed.

According to an aspect of the present invention, a method is provided for routing data for an application over a highest priority, available network selected from multiple networks that are assigned application-specific routing priorities. The method includes receiving data of the application and determining the highest priority network for the application based on the assigned application-specific priorities. The method also includes sending the received data over the highest priority network when the highest priority network is available and, when the highest priority network is unavailable, determining a next highest priority network for the application based on the assigned application-specific priorities. When the highest priority network is unavailable and the next highest priority network is available, the method includes sending the received data over the next highest priority network. According to another aspect of the present invention each of the multiple networks is a wireless network.

According to yet another aspect of the present invention, the determining the highest priority network and the determining the next highest priority network are based upon at least one port number associated with the received data. According to still another aspect of the present invention, the determining the highest priority network and the determining the next highest priority network are based upon at least one IP address associated with the received data. According to a further aspect of the present invention, the determining the highest priority network and the determining the next highest priority network are based upon at least one protocol of the received data.

According to another aspect of the present invention, the method includes storing a different priority for the highest priority network and the next highest priority network as a rule in a memory. According to yet another aspect of the present invention, the method includes applying the rule to multiple IP addresses. According to still another aspect of the present invention, the method includes subjecting the received data to the rule and ignoring, based upon a predetermined order for subjecting received data to multiple rules, another rule for routing data for the application.

According to an aspect of the present invention, a system is provided for routing data for an application over a highest priority, available network selected from multiple networks that are assigned application-specific routing priorities. The system includes a mobile router that receives data of the application. The mobile router includes a port routing table containing information that specifies, based on the assigned application-specific priorities, the highest priority network for the application and a next highest priority network for the application. The mobile router sends the received data over the highest priority network when the highest priority network is available. When the highest priority network is unavailable and the next highest priority network is available, the mobile router sends the received data over the next highest priority network. According to another aspect of the present invention, each of the multiple networks is a wireless network.

According to yet another aspect of the present invention, the information is at least one port number associated with the received data. According to still another aspect of the present invention, the information is at least one IP address associated with the received data. According to a further aspect of the present invention, the information is at least one protocol of the received data.

According to another aspect of the present invention, the port routing table contains the information as a rule specifying a different priority for the highest priority network and the next highest priority network. According to yet another aspect of the present invention, the rule specifies the priority for the highest priority network and the next highest priority network for multiple IP addresses. According to still another aspect of the present invention, the received data is subject to the rule and, based upon a predetermined order for subjecting received data to multiple rules, another rule for routing data for the application is ignored.

According to an aspect of the present invention, a system is provided for routing data for an application over a highest priority, available network from multiple networks that are assigned application-specific routing priorities. The system includes a host network server that receives data of the application. The host network server includes a port routing table containing information that specifies, based on the assigned application-specific priorities, the highest priority network for the application and a next highest priority network for the application. The host network server sends the received data over the highest priority network when the highest priority network is available. When the highest priority network is unavailable and the next highest priority network is available, the mobile router sending the received data over the next highest priority network.

According to an aspect of the present invention, a computer readable medium storing a computer program is provided that enables the specification of routing behavior for an application over a highest priority, available network from multiple networks that are assigned application-specific routing priorities. The medium includes a source code segment that receives data of the application. The medium also includes a port routing table containing information that specifies, based on the assigned application-specific routing priorities for the application, the highest priority network for the application and a next highest priority network for the application. The medium further includes a source code segment that sends the received data over the highest priority network when the highest priority network is available. When the highest priority network is unavailable and the next highest priority network is available, the received data is sent over the next highest priority network. According to another aspect of the present invention, each of the multiple networks is a wireless network.

According to yet another aspect of the present invention, the port routing table includes at least a port route type indicator field, an IP address field, a netmask field, a protocol type field, a port number field or a network ID field. According to still another aspect of the present invention, the network ID field includes a designator for each of the multiple networks and an assigned priority for each of the networks.

According to a further aspect of the present invention, the information includes a rule specifying a different priority for the highest priority network and the next highest priority network. According to yet another aspect of the present invention, the rule specifies the routing priorities for multiple IP addresses. According to still another aspect of the present invention, the received data is subject to the rule and, based upon a predetermined order for subjecting received data to multiple rules, another rule for routing data for the application is ignored.

According to a further aspect of the present invention, the information is a port number associated with the received data, an IP address associated with the received data or a protocol of the received data.

According to yet another aspect of the present invention, the medium includes an availability source code segment that ascertains the availability of the networks.

The prioritized alternate port routing functionality can be used to provide different priorities for routing packets of different applications. As an example, a mobile router can be defined to route packets over multiple networks including a wireless local area network (LAN), a CDMA 1xRTT network and a Motorola RD-LAP network. The mobile routing system administrator can define the prioritized alternate routing for each application in the Network ID fields of the port routing table. The prioritization can be set uniformly for all applications on the mobile computer. For all applications, the Wireless LAN will be used when in coverage, the CDMA 1xRTT network will be used if the Wireless LAN is out of coverage, and the Motorola RD-LAP network will be used when the Wireless LAN and the CDMA 1xRTT network are out of coverage.

The prioritized alternate port routing functionality can also set application-specific priorities. A web browser application may have a priority of 1 for the CDMA 1xRTT network, a priority of 2 for the Wireless LAN, and a priority of 3 for the Motorola RD-LAP network. A computer aided dispatching (CAD) application may have a priority of 1 for the Motorola RD-LAP network, a priority of 2 for the CDMA 1xRTT network, and a priority of 3 for the Wireless LAN. The alternate routing prioritization can also be set with one rule for multiple IP addresses without setting the alternate routing prioritization for all IP addresses maintained by the system administrator.

Accordingly, using the prioritized alternate port routing functionality, the system administrator has discretion to individually control the alternate routing characteristics of multiple applications.

Other exemplary embodiments and advantages of the present invention may be ascertained by reviewing the present disclosure and the accompanying drawing.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 is diagram of a wireless mobile routing system that includes a host network server, multiple wireless networks, and multiple mobile routing devices;

FIG. 2 illustrates a general overview of the mobile client side of the wireless mobile routing system that includes a mobile router;

FIG. 3 illustrates a software architecture for a host network server;

FIG. 4 is a flow chart showing an exemplary process executed by the host network server for processing incoming data received on a wireless network;

FIG. 5 shows an exemplary route table;

FIGS. 6, 7, and 8 are flow charts showing exemplary logic executed by the host network server for processing outgoing data;

FIG. 9 shows an exemplary software architecture for the mobile router in an initial state;

FIG. 10 shows an exemplary software architecture for the mobile router at a later state;

FIG. 11 shows an exemplary route registration packet;

FIG. 12 shows an exemplary graphical representation of port routing functionality, according to an aspect of the present invention;

FIG. 13 is an illustration of an exemplary port routing table having a variety of port routing configurations, according to an aspect of the present invention;

FIG. 14 is a flow diagram depicting an exemplary manner in which routes are registered, according to an aspect of the present invention;

FIGS. 15(a) and 15(b) are flow diagrams depicting an exemplary manner in which routes are looked up when port routing is enabled, according to an aspect of the present invention;

FIG. 16 is screen shot showing an exemplary port routing configuration screen in which the mobile administrator has added five specific routes, according to an aspect of the present invention;

FIG. 17 is a screen shot of an exemplary port routing configuration screen which allows editing of port routing entries, according to an aspect of the present invention; and

FIGS. 18(a) and 18(b) are screen shots of exemplary route table displays, according to an aspect of the present invention.

FIG. 19 is a flow diagram depicting an exemplary manner of obtaining a prioritized alternate route and routing a packet, according to an aspect of the present invention;

FIG. 20 is a flow diagram depicting an exemplary manner in which prioritized alternate routes are added to a port routing table, according to an aspect of the present invention;

FIG. 21 is an illustration of an exemplary enhanced port routing table for prioritized alternate port routing, according to an aspect of the present invention;

FIG. 22 is another illustration of an exemplary enhanced port routing table for prioritized alternate port routing, according to an aspect of the present invention;

FIG. 23 is a screen shot of an exemplary enhanced port route table display, according to an aspect of the present invention;

FIG. 24 is a screen shot of an exemplary enhanced port routing configuration screen, according to an aspect of the present invention;

FIG. 25 is another screen shot of an exemplary enhanced port routing configuration screen, according to an aspect of the present invention;

FIG. 26 is another screen shot of an exemplary enhanced port routing configuration screen, according to an aspect of the present invention.

### DETAILED DESCRIPTION

Wireless Mobile Routing System

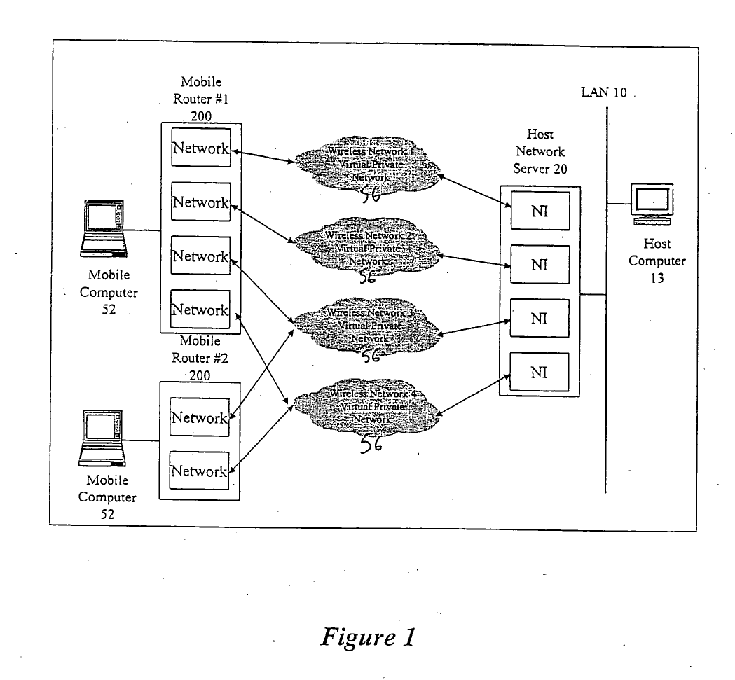

FIG. 1 shows an overall system diagram of an existing wireless mobile routing system which includes a Host Network Server 20 acting as an access point to a Local Area Network 10, multiple Mobile Routers 200, at least one host application 13 on the LAN 10, and multiple networks 56. Although FIG. 1 shows a host application 13 on the LAN 10, the wireless mobile routing system does not require a host application 13 on the LAN 10 because the wireless mobile routing system supports Mobile Router 200 to Mobile Router 200 communications.

The Mobile Router 200 can take many different forms. It can be created in hardware and can be physically separate from the mobile device 52. In another embodiment, the Mobile Router 200 can be completely developed in software and reside on the mobile device 52 in the device's operating system. In another embodiment, the mobile router can be created in silicon hardware and be present within the hardware of the mobile device 52.

With reference to FIG. 1, the mobile device 52 may comprise a software application running on a portable or laptop computer performing a variety of functions as programmed by the software application (e.g., database services). The mobile device 52 may be a special purpose device designed to perform a particular function, such as a credit card reader or barcode scanner. The mobile device 52 may generate a data stream that is sent to a fixed location (e.g., a host computer infrastructure 10).

An exemplary application running on the mobile device 52 is a mobile remote client application that provides the remote user with the capability to send and retrieve data from a fixed database server application. The data may include customer records which, for example, may be used by service personnel operating a fleet of vehicles to service customers scattered about a wide geographic area. In the exemplary application, the mobile client application may request customer records from the fixed database server, and display the records for viewing by mobile service personnel. The mobile client application may send updated records to the fixed database as the service personnel finish assigned tasks. The updated records may contain a service history, equipment upgrades, and repairs for each customer.

Another exemplary application running on the mobile device 52 may be a client application that retrieves a list of dispatched jobs to be performed by the service personnel during each day. The jobs may be uploaded to the remote mobile device 52 each morning and stored in another client application in the mobile device 52. As the service personnel change job locations, the status of each job may be updated to indicate a status, e.g., en route, arrived and finished with comments. The status may be sent from the application to the fixed home office, so a dispatcher at the home office is aware of the locations of service personnel in the field.

By way of non-limiting examples, the mobile device 52 may comprise a portable or laptop computer; a computer having an embedded Router 200; a terminal or terminal emulator; a data gathering device (e.g., a SCADA system or remote telemetry system for obtaining data from a remote location for forwarding to a central location for processing); a card-swipe reader device (e.g., credit/debit/bank cards) for use in a mobile billing application, such as a taxi or mobile food cart; a smart-card reader; a logging device, such as those used in a package delivery system or fleet; a device for reading bar codes (e.g., for inventory control); and a remote application with data to send or to receive, from a fixed device (e.g., remote diagnostic tool). The above-noted applications are provided merely for exemplary purpose, and other applications and mobile devices 52 may be used with Router 200.

As seen in FIG. 1, a one to many Virtual Private Network (VPN) is created between the one Host Network Server 20 and multiple Mobile Routers 200. Although not shown, a many to many Virtual Private Network can be created between multiple Host Network Servers 20 and multiple Mobile Routers 200. The Host Network Server 20 is connected to each Mobile Router device 200 by multiple networks 56. Data can be sent to each Mobile Router 200 without requiring the host application 13 residing on the LAN 10, or another mobile device 52, to select a network for transmission. That is, the host application 13 or other mobile device 52 can send data to a desired mobile device 52 without concerning itself with the network 56 that will actually transmit the data.

In one embodiment, data sent outbound from Host Network Server 20 is tunneled via an appropriate network 56 to the mobile device 52. Tunneling is defined as adding a header to a data packet in order to send the data packet between two locations while hiding the contents of the packet from other locations. The tunneling capability has long been used to bridge portions of networks that have disjoint capabilities or policies. As a result of this VPN, the end point IP addresses and devices are effectively hidden from any of the other network devices within the particular network. This VPN also supports both compression and encryption.

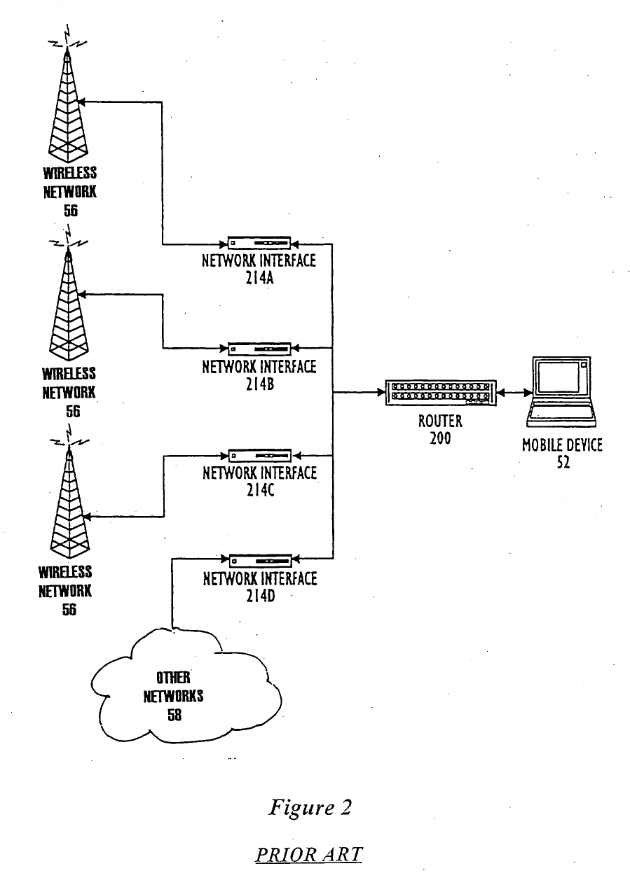

Referring now to FIG. 2, therein is illustrated a general overview of the client side of the wireless mobile routing system which includes a Mobile Router 200. The Router 200 provides the mobile device 52 with the capability to selectively transmit and receive data over multiple wireless infrastructures 56 and/or other networks 58 in accordance with user configured parameters.

Typically the mobile device 52 sends and receives data using a variety of protocols (e.g., Internet Protocol (IP)/transparent (via MDC 54)/ack-nack, etc.). The use of a variety of protocols provides for open transport of data throughout many networks, and in particular, networks which support open standards such as IP. However, many proprietary networks which require interface and/or protocol translation remain in use. In the Router 200 of the present embodiment, the function of interfacing with networks and protocol translation may be performed by the Network Interfaces 214A-D.

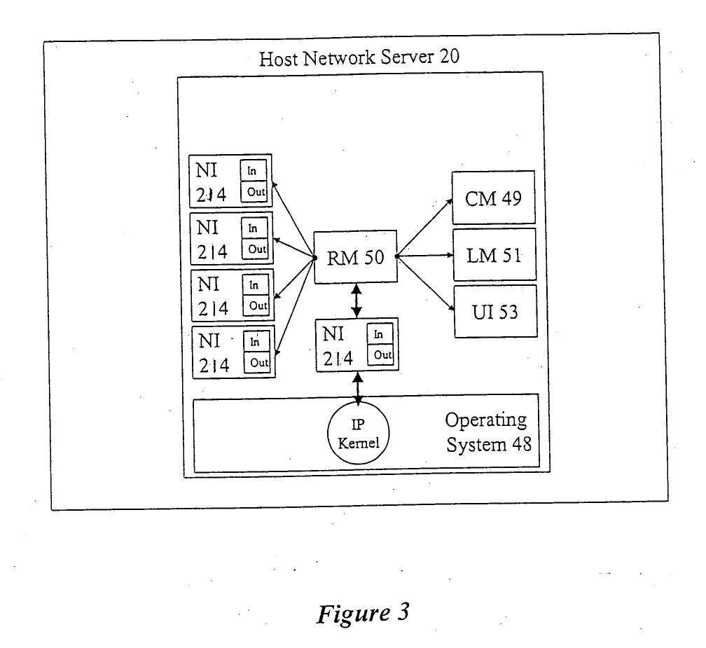

FIG. 3, shows an exemplary software architecture of the Host Network Server 20 at an initial state. The Host Network Server 20 runs on any operating system 48. An exemplary operating system is Microsoft Windows NT. The Host Network Server 20 contains several different processes, in addition to the operating system 48. A Configuration Manager (CM) 49 manages all the configuration parameters required for the Host Network Server 20. A Logging Manager (LM) 51 is responsible for managing any log messages generated from the modules. The Router Manager (RM) 50 is responsible for routing from source network interfaces to destination network interfaces 214. The Network Interfaces (NI) 214 are responsible for interfacing to each of the wireless networks 56. The Network Interface 214 is also responsible for converting the data from IP to the format required by the wireless networks 56. A user interface (UI) 53 provides an administrator with functions to control and administer the Host Network Server 20 including viewing the diagnostic logging information.

Upon startup of the Host Network Server 20, the Router Manager 50, Configuration Manager 49, and Logging Manager 51 processes begin. The Configuration Manager 49 is responsible for reading in configuration parameters from persistent storage. This configuration information specifies which Network Interfaces 214 should start. Such configuration information is determined by a system administrator. The configuration information specifies configuration options for all subsystems present in the system. Such configuration options for Network Interfaces 214 may include, for example, a network address for non-IP networks (e.g., a telephone number for a circuit switched cellular connection; or a modem serial number, a baud rate and serial port for a serial port connection) or an IP address for IP networks.

Once the Router Manager 50 begins, it attaches itself, through a Network Interface 214, to the IP stack of the operating system 48 and registers a local IP address specified in the configuration. By connecting to the IP stack, the Host Network Server 20 is permitted to send and receive IP datagrams directly to the IP stack. If the Host Network Server 20 is unable to bind this connection, the Host Network Server 20 displays a notification that routing to and from the LAN 10 is disabled. In this case, however, mobile users can still communicate with other mobile users. Assuming the Host Network Server 20 binds correctly, the Host Network Server 20 provides routing functionality and is responsible for sending data to the LAN 10 and receiving data from the LAN 10. The Router Manager 50 then starts the Network Interfaces 214 specified in the Configuration Manager 49.

Each Network Interface 214 is associated with a specific wireless network 56 and is responsible for sending and receiving data to and from the wireless network 56. Each wireless network 56 will require some type of transceiver or other device to communicate with the wireless network 56. An exemplary list of wireless network 56 transceivers includes private voice radio using e.g., the MDC 54 and a variety of radios, both conventional and trunked; Cellular Digital Packet Data (CDPD), such as Sierra Wireless or NovaTel CDPD modems; spread spectrum, either direct sequence, or channel-hop, such as Xetron Hummingbird spread spectrum modem; GSM, such as Ericsson serial GSM module; RDI (e.g., Ericsson) interface, implemented via a software protocol module and quasi-RS232 interface to radio; AMPS; Mobitex; DataTac, both public and private, Ethernet; Ardis; PCS; and any other network which is either transparent or operates using a specific protocol. The Network Interface 214 can connect to the wireless transceiver, which in turn allows communication through the wireless network. The Network Interface 214 can connect to the transceiver via many methods, including but not limited to: IP, X.25, a local modem connection, local serial port connection, USB, Ethernet, wirelessly, RS485 and any other connection medium which is either transparent or operates using a specific protocol.

Upon startup of the Network Interface 214, the module verifies its own configuration received from the Router Manager 50. If the configuration is invalid, the process displays an error message and may be unavailable for routing. If the configuration is successful and the required parameters are set correctly, the process starts its own initialization routine.

The type of network connection available determines the types of initialization that occurs. For example, in the case of a pure IP connection (i.e., a connection to an IP network), the Network Interface 214 opens a socket to connect to the IP address of the remote device. In the case of a serial connection to the network, the process opens the serial port and sets up the serial line parameters. If at any time the connection cannot be made, the process logs a message to the Logging Manager 52 and will be made unavailable for use. Once the Network Interface 214 completes its initialization, it starts its inbound and outbound threads to monitor the wireless networks 56 for sending and receiving data. After the inbound and outbound threads are started and the Network Interfaces 214 can successfully communicate to the network, the process threads wait for data on each of the networks 56.

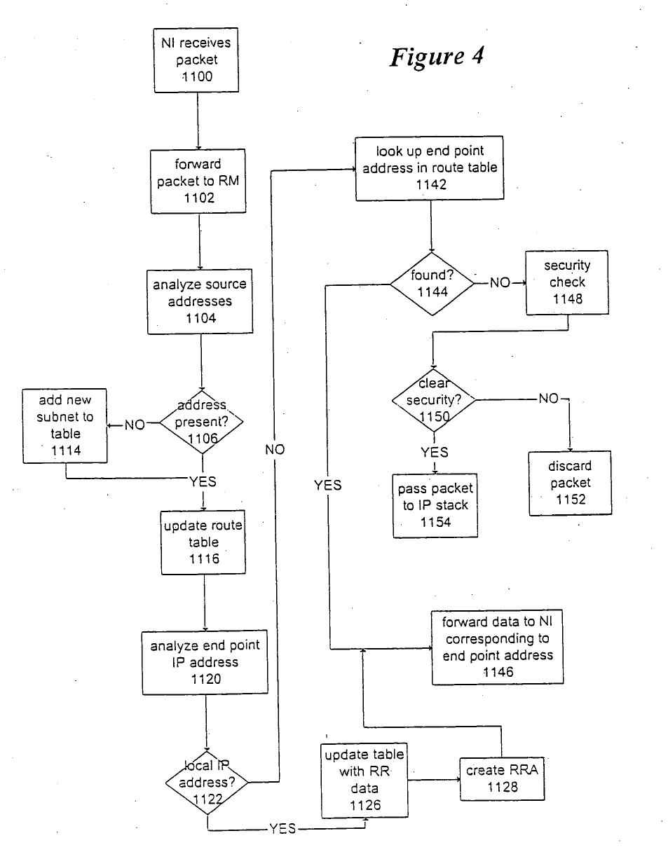

Processing of an inbound packet received from one of the wireless networks 56 is now described with reference to FIG. 4. If an inbound packet has been detected at one of the Network Interfaces 214, the Network Interface 214 receives the data from the network in the network's format at step 1100. Any framing and or error checking/correction required by the network will be performed to ensure the integrity of the data. The Network Interface 214 acknowledges (ACK) the wireless network provider if the provider requires it or provides a negative acknowledgment (NAK), if appropriate.

The Network Interface 4 then saves the source hardware addresses (e.g., modem serial number) of the inbound packet, if the wireless network 56 is a non-IP network. As an example, in the case of a circuit switched cellular connection, the hardware address would be a telephone number. If the wireless network 56 is an IP network, no hardware addresses are saved at this time because the packet itself includes the source and end point IP addresses. (In this document, the IP address of the mobile router will also be referred to as the end point IP address. It identifies the address of the router, not the address assigned by the wireless network, which will be referred to as the gateway address.) At this point, the Network Interface 214 strips off any headers or trailers placed around the received data by the network provider. The remaining data is the original data sent by the original mobile routing device 200.

The Network Interface 214 then creates an interprocess communication (IPC) packet that includes at a minimum, the original data, the length of the packet, the source network ID as well as the source and end point hardware addresses of the packet when the wireless network 56 is not an IP network. This packet is then sent to the Router Manager 50 process via the standard IPC mechanisms, at step 1102.

Once the Router Manager 50 receives the data from the interprocess communication (IPC) mechanism, the Router Manager 50 determines which interface sent the packet based upon a source network ID included in the IPC packet associated with the received data. The Router Manager 50 then validates the IP packet checksum. If the checksum fails, the packet is silently discarded. Otherwise, the received packet is verified as an IP version 4 packet. This information is readily available in the IP header. If the packet does not meet the version 4 criteria, then it is silently discarded. This process can also be modified to support IP version 6 or other protocols. The source IP address of the received packet (depending on the originating network) is then analyzed at step 1104. More specifically, at step 1106 the Router Manager 50 determines if the source IP address is present in a route table stored in persistent storage. In other words, the subnet on which the source IP address resides is looked up. If the source IP address is not present in the route table (step 1106=No), the Router Manager 50 then analyzes the end point IP address at step 1120.

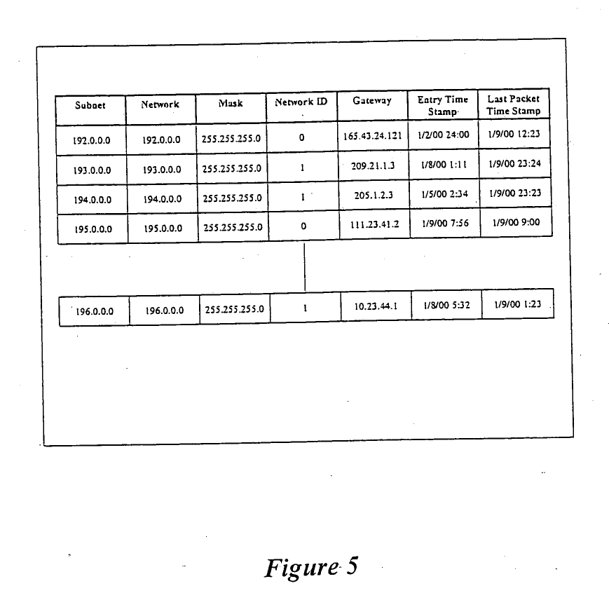

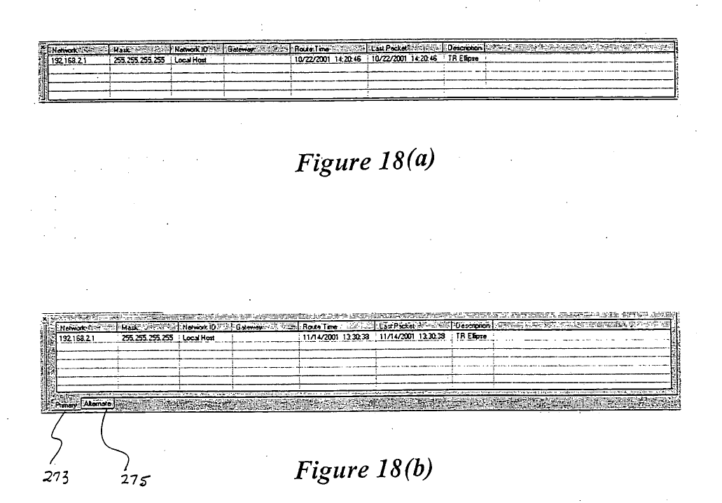

An exemplary route table is shown in FIG. 5. Furthermore, FIGS. 18(a) and 18(b) also show an example for presenting the route table to the user in a user readable format. The figures show an example of how the display of the route table can be shown to the user within a graphical user interface. If the IP address is present, the Router Manager 50 updates the route table to reflect that a packet has been received from the wireless network 56 (e.g., with a time stamp) at step 1116. Any route entry in the route table indicates that the associated route actively connects to the Mobile Router 200.

The route table includes three fields that correlate to the end point address: the Subnet field, the Network field, and the Mask field. As is well known, the subnet value is calculated from a bitwise AND operation of the mask value and the network value. The mask and network values are learned in a well-known way. Each end point address can then be classified into a subnet in a well known manner. Consequently, based upon the subnet in which the end point address is classified, a gateway address can be determined by examining the value in the Gateway Address field. The Network ID field stores arbitrary values corresponding to each Network Interface 214. Thus, by using the network ID value, the Host Network Server 20 knows which Network Interface 214 should be employed to communicate with the gateway address. The Entry Time Stamp field stores a time stamp entry indicating when an entry is first stored in the route table. The Last Packet field stores a value indicating the time when the last packet was received from the corresponding gateway address. The module 50 will then decrement the Time to Live (TTL) parameter in the IP header. If the TTL parameter is zero, then the packet is discarded and a Time to Live discarded message is sent back to the originator of the packet. At this point, it is logged into the database. Alternatively, the discarding/decrementing/logging process can occur at step 1104.

Once the route table is updated at step 1116, the Router Manager 50 analyzes the end point IP address at step 1120. At step 1122, the Router Manager 50 determines if the end point IP address of the packet matches its own local IP address. If these addresses match, the packet is for the local Router Manager 50. There can be several different types of packets that the Router Manager 50 can receive. One example includes a route registration (RR) packet. The Router Manager 50 updates the routing table with all of the addresses listed in the RR packet at step 1126, as well as the gateway address which the packet came in from. The Router Manager 50 process then creates a route registration acknowledgment (RRA) packet at step 1128 for forwarding back to the mobile router 200. Consequently, the Router Manager 50 passes the data to the appropriate Network Interface 214 corresponding to that mobile router 200 at step 1146.

If it is determined at step 1122 that the packet's end point address is not coincident with the Host Network Server's local IP address, the Router Manager 50 looks up the received end point address in the route table at step 1142. If the address is found in the local route table (step 1144:YES), the Network Interface 214 corresponding to that end point address is notified. The end point address can be another mobile routing device 200 or a host 13 on the LAN 10.

If it is determined that the packet is not in the route table at step 1144, then a destination unreachable message is sent to the originator of the packet. In one embodiment, all mobile users by default have the authority to send packets to any IP address and port combination on the LAN 10. In another embodiment, if the administrator wants to create a more secure network, the administrator creates a security database including all IP address/hardware address combinations to which each mobile device is authorized to communicate.

In this embodiment, the Host Network Server 20 checks the packet against its own security database at step 1148. More specifically, the Host Network Server 20 looks up the end point IP address and the destination port number in the security database. If an entry exists for the source address and end point address combination (step 1150:YES), the Router Manager 50 forwards the packet to the appropriate Network Interface 214 specified in step 1144 for eventual delivery to the end point address at step 1154. If the address does not exist in the table (step 1150:NO), a log message is created and the packet is silently discarded at step 1152.

This firewall functionality provides the additional benefit of preventing selected remote devices from accessing selected destinations. For example, an administrator may not want all mobile users browsing the company's intranet server via the wireless network. It is noted that all IP packets are verified against the security database in this embodiment.

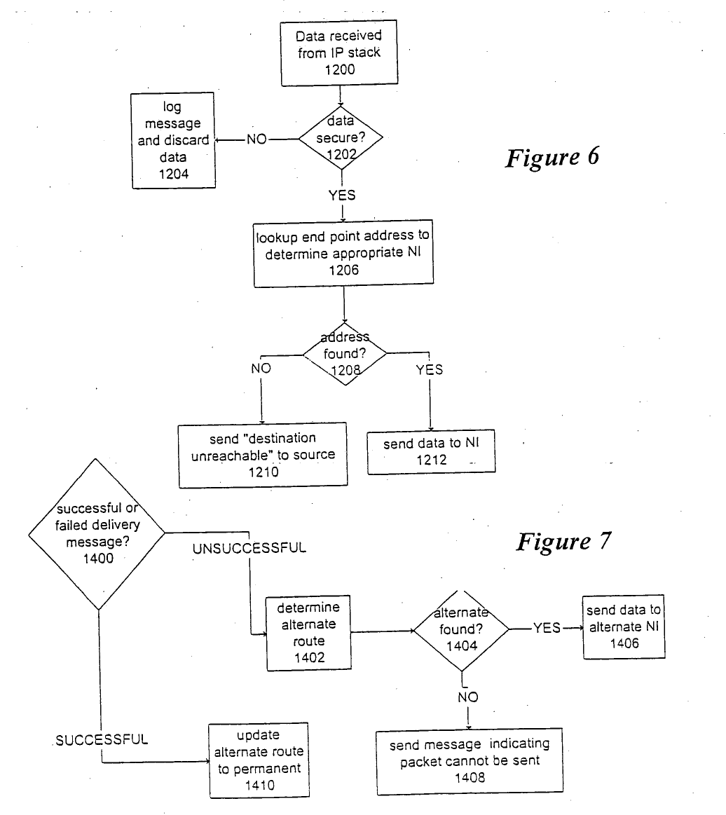

Processing of data received from the LAN 10 is now discussed with reference to FIG. 6. Data received from the LAN 10 in this scenario is outgoing data received from a host application 13 intended for a mobile router 200. If any data is received at the LAN 10 via a network adapter, the Router Manager 50 process receives the data at step 1200. The Router Manager 50 first validates the IP packet checksum. If the checksum fails, the packet is silently discarded. Otherwise, the received packet is verified that it is an IP version 4 packet. This information is readily available in the IP header. If the packet does not meet the version 4 criteria, then it is silently discarded. The module will then decrement the Time to Live parameter in the IP header. If the TTL parameter is zero, then the packet is discarded and a Time to Live discarded message is sent back to the originator of the packet.

The data packet is then scanned against the security database at step 1202. If the source address and end point address combination do not exist in the database, a message is logged and the packet is silently discarded at step 1204. Provided that the packet has passed the internal security checks, the end point address of the IP packet is looked up in the route table at step 1206. If the address is not found in the route table (step 1208:NO), the Router Manager 50 sends a destination unreachable message back to the original source address at step 1210. If a matching entry is found in the route table (step 1208:YES), the Router Manager 50 creates an IPC packet containing the original data, the message length, and the end point IP address (when an IP network) or end point hardware address (when not an IP network). The Router Manager 50 then sends the message to the Network Interface 214 process via the IPC channel at step 1212.

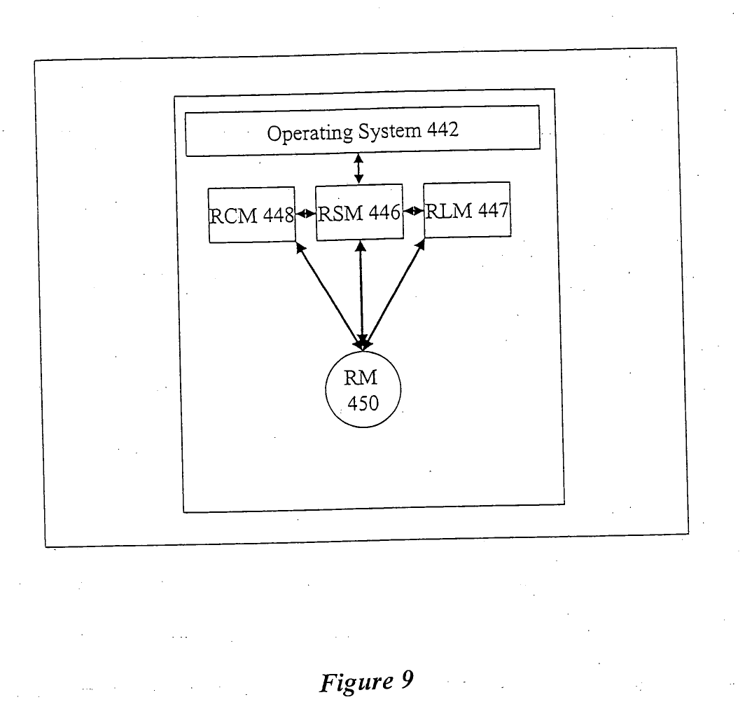

FIG. 8 illustrates the logic executed by the Network Interface 214 upon receiving the message from the Router Manager 50. Once the Network Interface 214 receives the data from the IPC channel at step 1300, it creates a data packet for the wireless network 56 at step 1302. The end point address of the packet sent from the LAN 10 was provided in the IPC message. At step 1304 it is determined whether the network is an IP network. If the network is an IP network, then a tunneled packet must be created. The source IP address of the packet is set to the local Network Interface 214 IP address and the end point IP address is set to a gateway address of the mobile routing device provided in the IPC message at step 1306. Gateway addresses are IP addresses corresponding to the wireless network 56, assigned by the wireless network provider. If the network is a non-IP network, the source address of the packet native to the non-IP format is set to the local Network Interface 214 hardware address at step 1308. The end point hardware address is the remote device's hardware address. Once the data packet has been created, at step 1310 it is sent to the wireless network provider using the format required by the wireless network provider for delivery to the mobile user. In certain networks, the modem is not always connected to the network (e.g., circuit switched cellular network). Therefore, before a packet is transmitted, some connection means must be initiated. It is the function of the Network Interface 214 to initiate this connection if it is required.

In an alternative embodiment, at step 1312 it is determined whether the packet has been successfully delivered. If for some reason, the Network Interface 214 cannot deliver the packet successfully to the mobile router 200, the Network Interface 214 sends a message back to the Router Manager 50 process to alert the Router Manager 50 that the Network Interface 214 was unable to successfully deliver the packet at step 1314. The Router Manager 50 decides to use a different route to the mobile destination, if one exists, when delivery was unsuccessful.

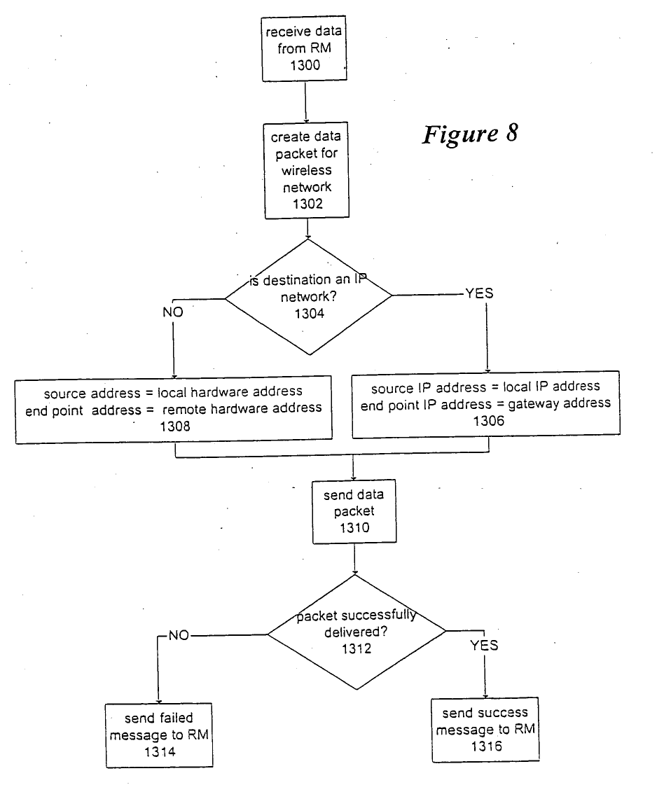

In the alternative embodiment, and with reference to FIG. 7, the Router Manager's logic for determining an alternate route is discussed. At step 1400 the Router Manager 50 determines whether the message received from the Network Interface 214 indicates unsuccessful delivery. If the message indicates that delivery was not successful, the Router Manager 50 then scans its internal configurations, at step 1402, to determine an alternate route. If an alternate route is found (step 1404:YES), the Router Manager 50 forwards the data packet to the Network Interface 214 corresponding to this new route at step 1406. The logic described with reference to FIG. 8 then repeats and the Router Manager 50 awaits a message indicating whether the transfer was successful.

In the alternative embodiment, if the Network Interface 214 was successful in delivering the packet, the Router Manager 50 receives a message from the Network Interface 214 indicating that the route was successful (step 1400:SUCCESSFUL). Consequently, the Router Manager 50 makes the route permanent at step 1410. If all the routes have been tried and the packet cannot be successfully delivered (step 1404:NO), then a destination unreachable message is sent back to the source of the packet at step 1408.

The Host Network Server 20 also provides the administrator with statistical information regarding data that passed through the system. Any event that occurs will increment a counter on a user-by-user basis. These statistics can be presented to the user in many different formats. The statistics can be useful for administrators to pinpoint problems with certain mobile devices, comparing bills from the service provider to actual usage, etc.

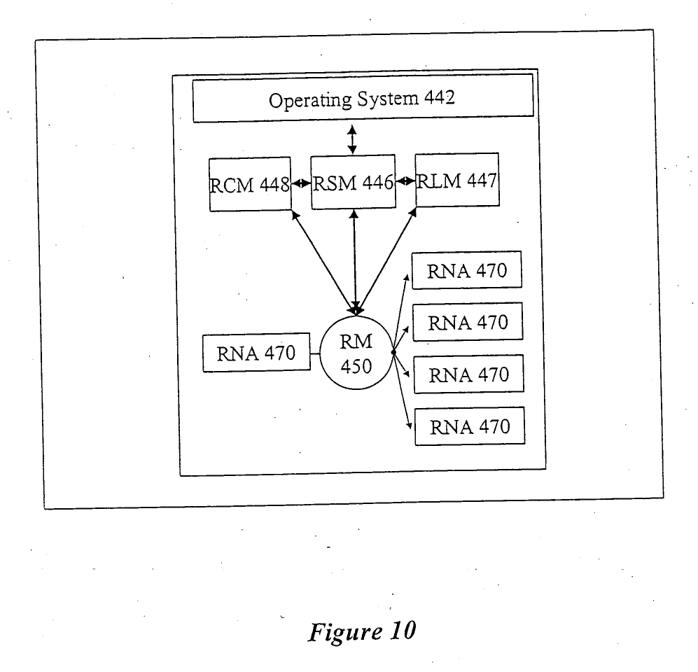

FIG. 9 shows a software architecture that permits a mobile device 52 to communicate with a Host Network Server 20 on a Local Area Network 10. The software may reside on each mobile device 52 eliminating the need for the Mobile Router 200, or in an alternate embodiment, the software may reside on the Router 200, which is physically separate from the mobile device 52. The software may also be provided as hardware or a combination of software and hardware.

The operating system 442 is the mobile device's operating system when the mobile device 52 executes the routing software of the present invention. If a separate router 200 is provided, the operating system 442 runs on the Mobile Router 200. Any type of operating system 442 can be used to run the software. Exemplary operating systems include C Executive, available from JMI Software Systems, Inc., and Microsoft Windows CE, 95, 98, NT, 2000 or XP, available from Microsoft Corporation.

As a non-limiting exemplary hardware implementation, the Mobile Router 200 may include an 586 microprocessor, running at 266 MHZ, 256 kilobytes of FLASH ROM, 256 kilobytes of static RAM, six asynchronous serial ports, two TTL-to-RS232 converters interfacing with two of the six serial ports directly to compatible devices external to the Switch 212, and four internal TTL serial interfaces to internally-mounted daughter boards, which carry Network Interfaces 214A-D. Each Network Interface 214 mounted on a daughter board may include a power supply for the Network Interface, a serial interface to the microprocessor, and an interface to the outside network. The outside network may be a radio, a LAN, an antenna (for internally-mounted radios in the Network Interface 214), or other device accepting or supplying data from/to the Router 200.

The routing software starts once the operating system 442 has started. More specifically, once the operating system 442 successfully starts, it initiates one asynchronous process, the Router System Module 446 (RSM). The Router System Module 446 (RSM) is responsible for launching the Router Configuration Module 448 (RCM), Router Logging Module (RLM) 447 and the Router Module 450 (RM).

The Router Configuration Module 448 (RCM) is responsible for reading configuration data for the interfaces to the wireless networks 56 (for output) and to the mobile device 52 (for input). The mobile device 52 (i.e., client) is envisioned to be any device that can receive and/or send data to the routing software (e.g., mobile computer, GPS Reader, Card Reader, etc.). The Router Module 450 is responsible for making routing decisions on the available networks, once all networks are initiated. The Router Logging Module is 447 responsible for capturing and saving any diagnostic log messages generated from the applications. If any of these processes fail to start, the user of the mobile device 52 is alerted by a suitable means supported by the operating system 442.

Any number of mobile devices 52 and output devices (e.g., transceivers such as modems interfacing with the wireless networks 56) can be used. The number is only limited by the availability of hardware interfaces to the devices (e.g., serial ports, USB ports, PC card slots, parallel ports, etc.). Common configurations include two mobile devices 52 (e.g., mobile computer and GPS transceiver) and one wireless network 56 (e.g., CDPD), one mobile device 52 (e.g., mobile computer) and two wireless networks 56 (e.g., CDPD and private RF), or two mobile devices 52 (i.e., mobile computer and GPS transceiver) and two wireless networks 56 (e.g., CDPD and private RF).

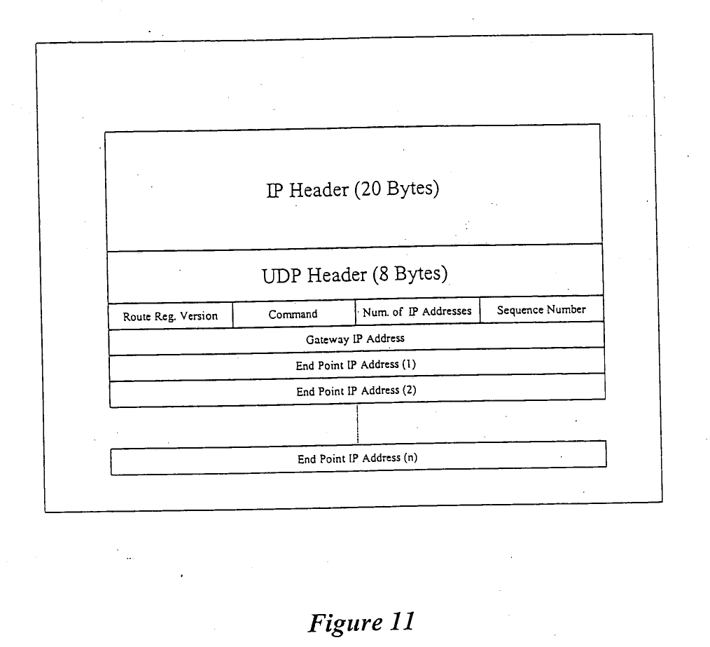

FIG. 10 shows the Router 200 after all appropriate processes have been launched. Two types of interfaces can be started and configured. The first type includes a standard Routing Network Adapter (RNA) 470 that is responsible for communicating to a communications device. This communications device can include a computer 52, or a network device such as a wireless modem. These processes manage the flow of data to and from the mobile routing device 200. The second type of interface is called the Auxiliary Feature Shell (AFS) also known as Auxiliary Feature (AF). The AFS processes can be a stand-alone application(s) developed to perform a specific function. The function does not have to involve routing of data or wireless networks. An exemplary AFS process provides support for global positioning system (GPS) and application programmers interface (API) functionality.

Each Router Network Adapter (RNA) 470 is responsible for dealing with network device specific behaviors. The Router Network Adapter 470 is responsible for the device specific functionality including device initialization, device termination, status checks, protocol conversion, packetization, etc.

A variety of messages can be sent from the Router Network Adapter 470 to the Router Module process 450 including at least a NetworkDown message and a NetworkUp message. The NetworkDown message informs the router that the wireless network 56 is not available for reasons such as hardware failure, out of wireless coverage, etc. The NetworkUp message alerts the Router Module 450 that the wireless network 56 is up and can be used for communications. All Router Network Adapters 470 initially start with the initial state of NetworkDown.

The Router Network Adapter 470 begins by initializing the assigned hardware device. Every device requires its own set of initialization functions. The Router Network Adapter 470 begins by opening up a hardware connection to the device. This connection can be, but is not limited to RS232, Universal Serial Bus (USB), Ethernet, Token Ring, IRDA, Parallel, Bluetooth, or any other communications port supported by the operating system 442. For most network devices, the Router Network Adapter 470 then performs initialization routines set by the device manufacturer and/or wireless network provider. Examples of these initialization routines include using AT commands, user defined protocols, etc. to start the device's communications link to the wireless network 56. If any of the initialization routines fail, the Router Module 450 is aware of the fact because the initial start state is NetworkDown. At this point, with no inbound or outbound data activity occurring, the Router Network Adapter 470 attempts to gather network status information from the hardware device.

Two methods for network status queries are used by modem manufacturers. In the first method, modems require the software to query the modem for its status, using some predefined set of commands. After the modem receives this status query, it queries the wireless network and returns the current status of the modem back to the software. For example, the modem can indicate that it is out of range. The drawback to this method of status query is that the software is tasked with querying the modem on a regular interval. This interval should be as short as possible, but not so short as to impact the normal data transfer functionality of the modem.

In the second method, modems provide unsolicited responses regarding network status. For example, the software receives status query responses without having to send the modem a command. Usually the modem responds by either sending back a status response packet or by changing the state of the hardware connection (e.g., RS232 DCD line). The advantage of transceivers using the second method of status reporting is that the switching to and from the network occurs instantly when the network status changes rather than waiting for the software to query the modem on a regular basis. Whenever the status of one of the hardware devices has changed from its previous state, the Router Network Adapter 470 sends a message to the Router Module 450 with the updated status.

Each Router Network Adapter 470 is configured with the gateway IP address from the configuration data block. This gateway IP address or hardware address is used to route packets through to get to the mobile device 52 or Host Network Server 20 and is referred to as the network's gateway Address.

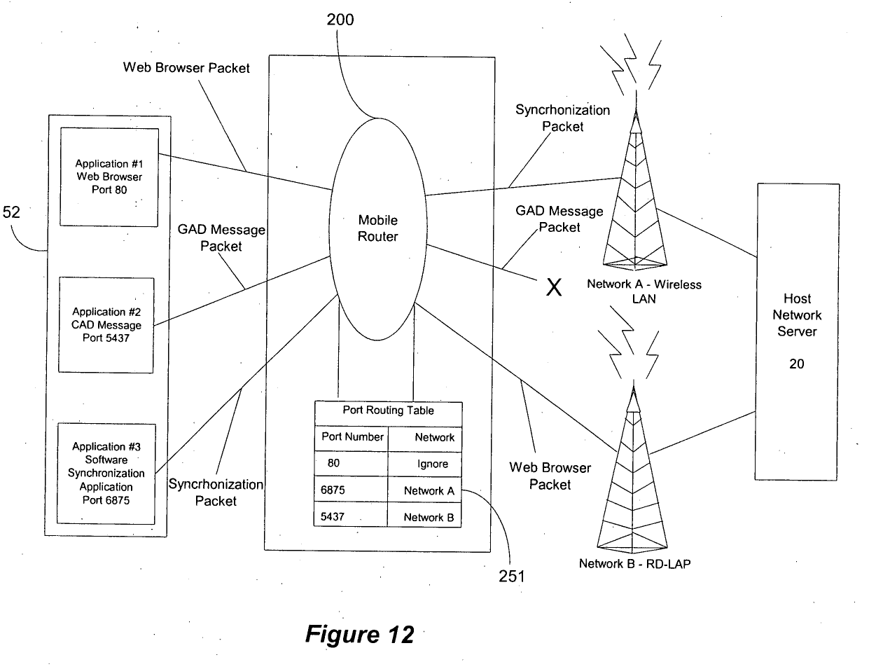

The Router Module process 450 listens to all available interfaces to determine network availability. The Router Module 450 requires the NetworkUp message to have been received before a wireless network 56 can be selected as the default route. The Router Module 450 then uses a variety of methods for determining network selection, such as time of day, message priority, and message size, but the final determination is always network availability, as previously discussed. Once the Router Module process 450 has determined the actively selected network, it updates its own internal route table to reflect the change. The Router Module 450 then generates a Route Registration (RR) message, an example of which is shown in FIG. 11, and sends it to the Host Network Server 20.

This RR message includes the following fields: Version, Command Number, Number of IP Addresses, a sequence flag, Gateway IP Address, and End Point IP Addresses. The Version byte specifies the version of the message. The Command bytes specify the type of message. The message types include Route Registration, Route Registration Acknowledgment and System Crash Route Registration. The number of IP addresses sets the number of addresses that are listed in the RR. The Gateway IP Address is the address of the currently selected hardware device. The list of IP addresses includes all of the end point IP addresses or subnets that can be reached via the gateway address. In other words, the software functions like a hub when more than one mobile device 52 is connected. For example, the software can be located in an automobile trunk and different mobile devices 52 could be located in the passenger compartment.

The RR alerts the Host Network Server 20 in order to update the route table as to all the end point IP Addresses that can be reached through this gateway address 56. Because the present invention allows for simultaneous parallel transmissions and multiple client devices, the RR ensures that the Host Network Server 20 is aware of all IP addresses that can be reached through this current gateway IP address. The Router Module 450 then waits for a Route Registration Acknowledgment (RRA) from the Host Network Server 20. If the Router Module 450 does not receive the RRA within a predefined time period, then additional RRs are sent at regular intervals until an acknowledgment is received. This retrying mechanism ensures that, even if the Host Network Server 20 is down, when it is restarted its route table always reflects the current routing configuration. If the Router Module 450 selects more than one network for the transmission of data, the route table is updated accordingly. The RR is then modified to alert the Host Network Server 20 to include both networks as the default route.

The Router Network Adapter 470 continually monitors the status of the networks 56. The Router Module 450 continuously passively monitors each RNA 470 for status change information. If a network's status changes at anytime, the appropriate RNA 470 sends a NetworkDown message to the Router Module 450. The Router Module 450 then dynamically changes the active route. The Router Module 450 can also use external influences, such as time of day, to dynamically change the route. This procedure for changing the route occurs transparently and independently from the normal transfer of packets.

At this point, any data received from any of the Router Network Adapters 470 is sent to the Router Module 450. The Router Module 450 verifies the IP checksum of the packet. If the packet's checksum fails, the packet is discarded. If the packet checksum is correct, the received packet is verified that it is an IP version 4 packet. This information is readily available in the IP header. If the packet does not meet the version 4 criteria, then it is silently discarded. The module will then decrement the Time to Live parameter in the IP header. If the TTL parameter is zero, then the packet is discarded and a Time to Live discarded message is sent back to the originator of the packet. The Router Module 450 looks at the end point IP address of the packet and routes it to the appropriate Router Network Adapter 470 or the appropriate end point IP address.

Next, the Router Network Adapter 470 receives the IP datagram from the Router Module 450. If the network is not an IP capable network it creates a data packet in the format required by the wireless network 56. The end point address of the newly created packet will be the hardware address (for non IP networks) of the corresponding interface on the Host Network Server 20. If the packet is an IP packet, it will be forwarded to the IP address of the corresponding Network Interface 214 (e.g., modem) on the Host Network Server 20. By sending to only the addresses of the interfaces on the Host Network Server 20, the user is assured that the packet will only go to the Host Network Server 20, even if the eventual destination of the packet has a different address. This ensures that the Host Network Server 20 can update and maintain its statistics and reporting capabilities. Additionally, it ensures that the Host Network Server 20 is always aware of the most recently used network, as well as the activity of all the mobile users. If the network 56 requires some procedure to establish a connection, then the Router Network Adapter 470 is responsible for this procedure (e.g., dialing a phone number on a circuit switched cellular network).

The second type of process that can be created is the AFS process. This process can be a standalone application that executes within the confines of the mobile routing device. It can perform any custom task that an end customer requires. An example is a store and forward process. The process can be written to manage the queuing of data, delivery of data and retrying of data transmissions.

The Router Module process 450 also supports the ability to dynamically alter the configuration of the software and determine a status of the software. The Router Module process 450 listens to an IP socket for any configuration requests. The configuration requests can come from either the mobile device 52 or the host application 13 on the LAN 10. The configuration requests are formatted in an IP UDP data packet. The Router Module process 450 always responds to the configuration request with a configuration response. Examples of these configuration requests include manually changing the route, requesting the network status, requesting the configuration, setting the configuration, etc. This functionality allows external applications to dynamically alter the routing of the device.

Port Routing System Overview

The present invention enhances the aforementioned wireless mobile routing system. With port routing, the Mobile Router 200 will not only simply notify the Host Network Server 20 of changes to the default network, the Mobile Router 200 will also notify the Host Network Server 20 whenever any network becomes available. The notification will allow both the Host Network Server 20 and the Mobile Router 200 to route packets over alternate, non-default networks as appropriate. The Mobile Router 200 will also be able to continue to route packets over the default network when appropriate.

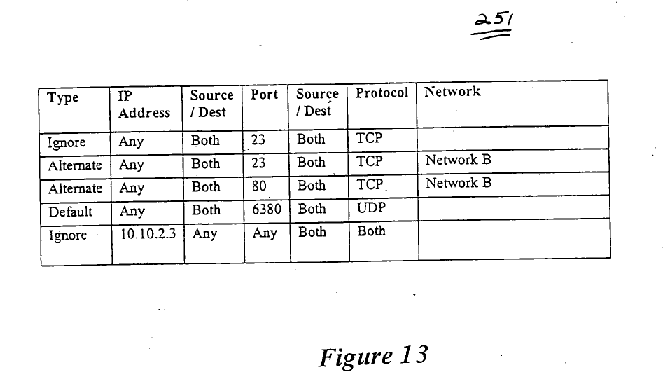

FIG. 12 is an illustration that represents an exemplary wireless mobile routing system having the port routing enhancement. In this example, three different applications (Application #1: web browser, port 80; Application #2: CAD message, port 5437; and Application #3: synchronization application, port 6875) are concurrently being executed on the mobile device 52. Data from the applications is being sent to the Mobile Router 200. When the Mobile Router 200 receives the data packets, the Mobile Router 200 consults a Port Routing Table 251 to determine which wireless network 56 (e.g., Network A: Wireless LAN and Network B: RD-LAP) the data should traverse to reach the Host Network Server 20. In the example shown in FIG. 12, data packets from Application #1, i.e., port 80, are not forwarded to the Host Network Server 20 because an “Ignore” indicator has been specified by the system administrator. On the other hand, data packets from Application #2, port 5437, are forwarded through Network B (RD-LAP) because the system administrator has specified Network B as the port routing path for port 5437. Similarly, data packets from Application #3, port 6875, are forwarded through Network A (Wireless LAN) because the system administrator has specified Network A as the port routing path for port 6875.

Port Routing Functionality and Port Routing Table

The functional details of port routing are now described. As discussed above, an aspect of the present invention includes the Port Routing Table 251. The Port Routing Table 251 stores additional configuration entries to support the enhanced routing capabilities. In one embodiment, the table includes fields enabling system administrators to specify port routing at a granularity that includes the protocol, IP address, port number and the specific network for routing. One embodiment of the Port Routing Table 251 includes five different fields that contain specific routing information, including port route type, protocol type, IP address, port number and the specified network.

The above mentioned system supports the ability to provide bi-directional communications. This being said, mobile routers can send packets inbound to the host network and the applications residing on the host network can send packets outbound to the mobile routers. Because of this bi-directional nature, a port routing table should exist on both the mobile routers and the host network server. Therefore, regardless of which side initiates the transmission, the packet will travel over the correctly chosen network.

In one embodiment, the Port Route Type field will contain an “Ignore”, “Alternate” or “Default” keyword. Each keyword specifies the routing behavior for a packet meeting user defined criteria when the packet is received by the Mobile Router 200.

If a packet's characteristics match user defined criteria stored in the Port Routing Table 251 and the corresponding Port Route Type field contains the “Ignore” network indicator value, then that packet will be returned to the source, without being sent across a wireless network, as a destination unreachable Internet Control Message Protocol (ICMP) packet. ICMP packets are provided to allow gateways or computers in a network to report errors or provide information about unexpected circumstances. There are several types of ICMP packets that can be generated, many specifying a type of error condition. The port routing within the Mobile Router 200 generates a destination unreachable message under certain conditions, such as when a packet cannot traverse a network to reach its destination.

If a packet's characteristics match user defined criteria stored in the Port Routing Table 251 and the corresponding Port Route Type field contains an “Alternate” network indicator value, then the packet will be sent through the specified alternate wireless network.

If the packet matches an entry in the Port Routing Table 251 that contains a “Default” network indicator value, then the packet will be sent through the default network. Initially, the Default network type appears redundant because a Default route exhibits the same functionality as when no entry is present in the Port Routing Table 251. However, the Default route does become valuable when used in conjunction with a non-specific Ignore route. As an example, if a user adds an Ignore port route to automatically ignore all TCP applications, he may then want to add a Default route for port 80 (web browser). The addition of these two routes will disallow any TCP applications except for web browsers. The web browsers will then use whichever network is default.

The IP Address field will identify at least one IP address associated with the packet received by the Mobile Router 200. It can represent “All” IP addresses, or a specific IP address. If a specific IP address is entered, then the user has the choice of specifying if the IP address appears in either the source or the destination address.

The Protocol Type field identifies what type of transport level protocol will be subject to the port routing functionality. For instance, an embodiment of the present port routing invention may control TCP packets, UDP packets or packets with either protocol. TCP and/or UDP applications may take advantage of the port routing capability, because TCP and UDP protocols have the notion of a port. Route registrations may still be maintained with backwards compatibility to ensure non-port routing Mobile Routers 200 will continue to function.

The Port Number field identifies the IP port number of the packet received by the Mobile Router 200. The user can specify all ports, or has the option of specifying an individual port. The user also has the choice of specifying if the port number appears in the source or destination location in the TCP or UDP header.

The Network ID field identifies which network will be used to route the above-mentioned applications. This field would only be applicable if the route type is designated as “Alternate”. The route for a “Default” entry in the table will be the highest priority, available network specified in a master route table, e.g., the route table shown in FIG. 5.

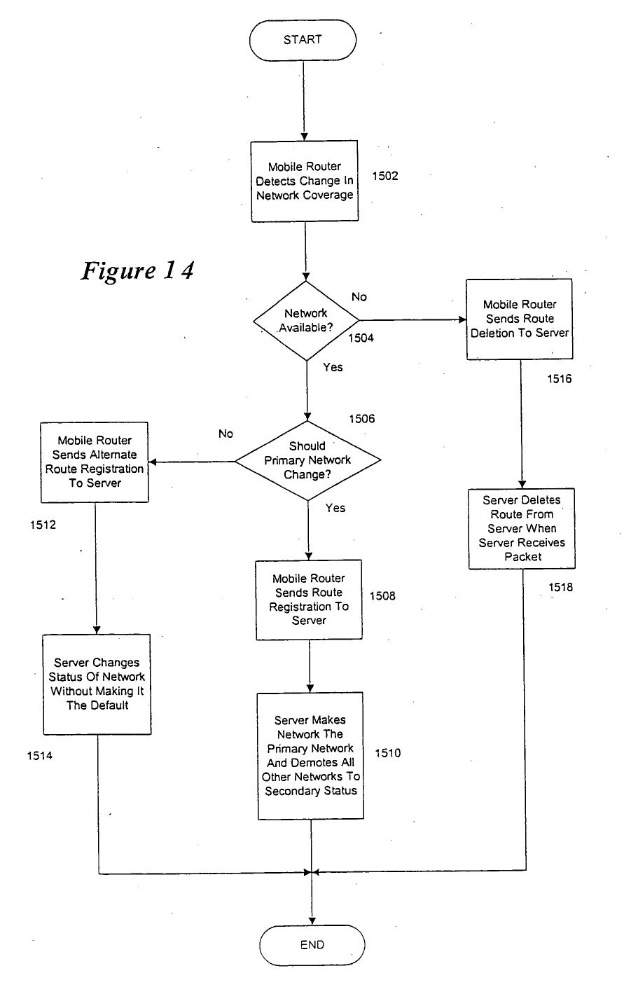

FIG. 13 shows an exemplary Port Routing Table 251 with a variety of port routing configurations. As seen in FIG. 13, it is possible to add many different port routing entries within the Port Routing Table 251. When looking up data in the Port Routing Table 251, the Mobile Router 200 always looks from the first entry to the last entry.

In the first row of the Port Routing Table 251, port routing is configured such that any TCP packet to or from port 23 that is received will be ignored. This route is referred to as an “Ignore” route. This port routing configuration does not allow the TELNET application to function through the Mobile Router 200. There is no need to define a network in the Network ID field because the data packets will not be routed over any network.

In the second row, an “Alternate” entry specifies that packets to or from port 25 will automatically be routed over the specified alternate network, which is Network B in this case. For example, this would only allow port 25 applications to function when the Mobile Router 200 is in range of a certain network, i.e., Network B.

In the third row, the “Alternate” entry specifies that the Mobile Router 200 will explicitly route web browser packets (Port 80), in this case over Network B. As an example, this port routing configuration might be used if an administrator does not want her users to run web browsers over any network other than Network B.

In the fourth row, a “Default” entry is present. The “Default” entry specifies that any packet sent or received with the port number 6380 will use the current default network. In this example, the current default network is Network A. This behavior is also functionally similar to not using port routing.

In the fifth row, an “Ignore” entry is present. The “Ignore” entry specifies that any packet received with either a source or destination IP address of 10.10.2.3 will be discarded. There is no need to define a network in the Network ID field when an “Ignore” entry is present because the data packets will not be routed over any network. An example use of the Ignore entry is to restrict the communications to certain servers.

The above noted functionality may be implemented in either a distributed configuration or a centralized configuration. In a distributed configuration, all Mobile Routers 200 implementing port routing are configured separately. In centralized configuration, a system administrator may configure port routing (as well as other aspects of Mobile Router 200 configuration) on the Host Network Server 20 and have the configuration pushed to each Mobile Router 200

Aside from the static configuration defined in the Port Routing Table 251, there is additional data that must be shared at run time between the Mobile Router 200 and the Host Network Server 20 for port routing to function properly. Currently, mobile clients only notify the Host Network Server 20 of changes to the default network for that mobile client. In order for port routing to function properly, the mobile clients should enhance their operation to notify the Host Network Server 20 whenever any network enters an “in-coverage” state or an “out-of-coverage” state. In addition, a network should be considered active for the Mobile Router 200 when the Mobile Router 200 is “in coverage” of the network. The Host Network Server 20, in turn, should be enhanced to allow for multiple entries in its master route table for the same destination range while providing the ability to designate one network as the default route.

Port Routing Logic

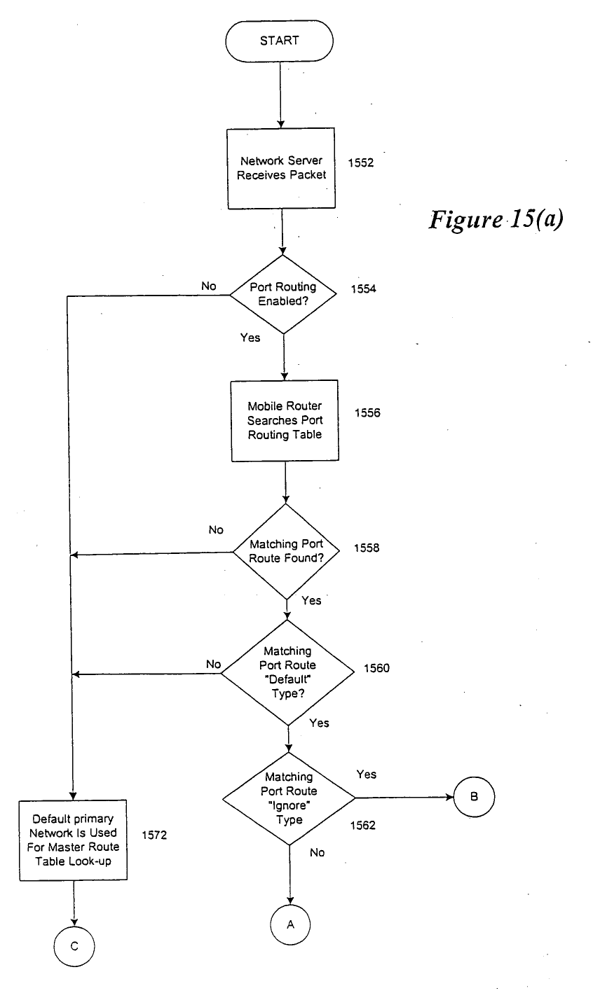

FIG. 14 is a flow diagram that depicts an exemplary manner in which the Host Network Server 20 monitors the networks registered in each Mobile Router 200. For port routing to operate correctly, the Host Network Server 20 must know the availability of all networks registered in each Mobile Router 200.

At step 1502, the Mobile Router 200 detects a change in network coverage. Next, at step 1504, it is determined if a network has become available. If a network has become available, then the Mobile Router 200 decides if the primary (i.e. active default) network should change at step 1506. If the primary network should change, the Mobile Router 200 sends a primary registration to the Host Network Server 20 at step 1508. Once the Host Network Server 20 receives the packet at step 1510, the Host Network Server 20 automatically designates the network as the primary network, thus demoting all other networks to secondary. A route registration acknowledgement is sent and then the logic sequence ends.

If at step 1506 the primary network should not change (i.e., a backup network came into coverage), then the Mobile Router 200 sends an alternate route registration to the Host Network Server 20 at step 1512. When the Host Network Server 20 receives the alternate route at step 1514, the Host Network Server 20 then updates the status of the network without making it the default. Next, the logic sequence ends.

If at step 1504 the network is not available, then the Mobile Router 200 sends a route deletion message to the server at step 1516. Then when the Host Network Server 20 receives the route deletion message at step 1516, it will automatically delete that route from its table. Thereafter, the logic sequence ends.

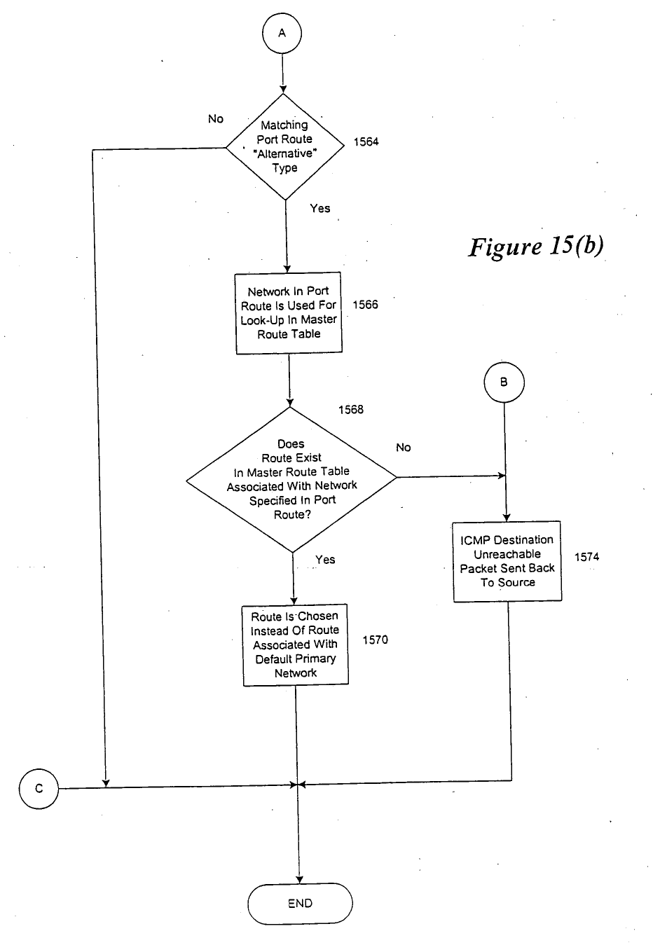

FIGS. 15(a) and 15(b) depict an exemplary manner in which routes will be determined in accordance with an aspect of the present invention. At step 1552, the Mobile Router 200 receives a packet. Next it is determined whether port routing is active at step 1554. If not, the packet is routed over the default primary network at step 1572. Then the logic sequence ends.

If at step 1554 port routing is found to be enabled, the Mobile Router 200 searches the Port Routing Table 251 at step 1556. If at step 1558 the packet does not match any of the entries in the Port Routing Table 251, the packet is routed over the default primary network at step 1572. Then, the logic sequence ends.

If at step 1558, the packet does match an entry in the Port Routing Table 251, the logic proceeds to step 1560. At step 1560 it is determined whether the matching entry includes a route type of “Default”. If so, the packet is routed over the default primary network at step 1572. Then, the logic sequence ends.

If at step 1560 a “Default” type is not found, the logic proceeds to step 1562. At step 1562, the logic determines if the matching entry has a route type of “Ignore”. If so, the packet is discarded and an ICMP destination unreachable packet is sent back to the source at step 1574. Subsequently, the logic sequence ends.

If at step 1562 an “Ignore” type is not found, the logic determines if the matching port route entry has a route type of “Alternate” at step 1564. If “Alternate” has been specified, the network identified in the Network ID field is used for a lookup in the master route table (FIG. 5) at step 1566. Then the logic proceeds to step 1568 to determine if a route exists in the master route table associated with the network identified in the Network ID field. If at step 1564 the route is not an “Alternate” type, the logic sequence ends.

If at step 1568 no route exists in the master route table associated with the network listed in the Network ID field, then the packet is discarded and an ICMP destination unreachable packet is sent back to the source. For example, this would occur at step 1574 when the network identified in the Network ID field is not available (e.g., out of coverage, low signal strength, etc.). Then, the logic sequence ends. If at step 1568 a route exists in the master route table associated with the network listed in the Network ID field, then the logic proceeds to step 1570 where the packet is routed over the network identified in the Network ID field instead of the route associated with the default primary network. Subsequently, the logic sequence ends.

It should be noted that even though FIGS. 15(a) and 15(b) depict an exemplary manner in which the Mobile Router 200 receives a packet, the same logic may be used for port routing outbound from the Host Network Server 20.

Port Routing Configuration Screen, Editing Screen, and Default Route Table

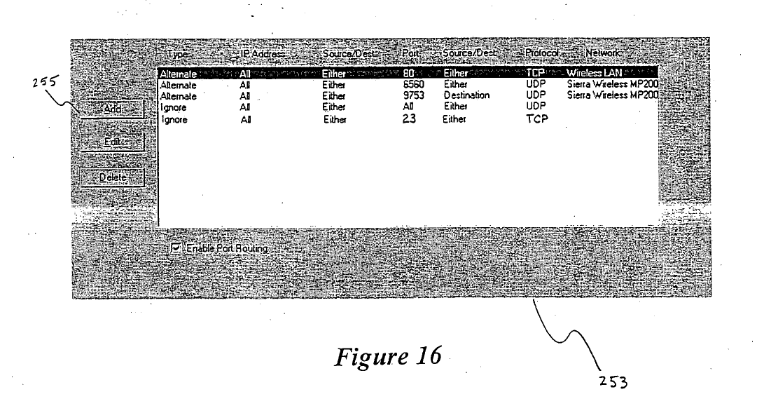

FIG. 16 is an exemplary screen shot that shows a Port Routing Configuration Screen 253. In this example, the mobile administrator has added several specific port routes. In the first row, the user specifically added a port routing definition to force all TCP packets with an 80 in either the source or destination port field over the network with the ID of Wireless LAN. In the second row, it is specified that all UDP packets with 6560 in either the source or destination port field will be forced to be sent over the Sierra Wireless MP200 network. A third entry specifies that any packet having a destination port of 9753 will also be forced over the Sierra Wireless MP200 network. In the fourth row, because an Ignore route with a wildcard port number is selected, all packets received with any port number either in the source or destination field will be ignored. The fifth line is an entry that requires specifically ignoring any packet with a destination or source port number of 23.

If or when there are no specific port routing entries listed in the Port Routing Table 251, the port routing functionality is disabled. In this circumstance, the default routes are being accepted. In this state, the Port Routing Configuration Screen 253 would inform the user that all traffic will be routed according to whichever network is available and selected as the highest priority default network.

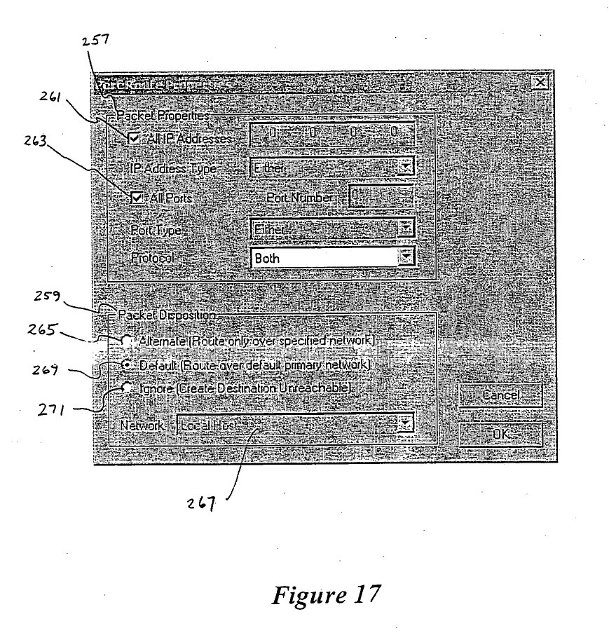

FIG. 17 is a screen shot of an exemplary port routing screen that allows the user to edit the port routing configuration. With this screen, the user would be able to add a configuration for the port routing. This screen appears when the user clicks the Add Button 255 from the Port Routing Configuration Screen 253, as depicted in FIG. 16.

The configuration window is separated into two sections. In the Packet Properties section (257, top half), the user is able to specify the actual packet criteria to which the specific rule should be applied. In the Packet Disposition section (259, bottom half), the user will be able to specify the routing of the packet that the rule describes.

The “All IP Address” check box 261 specifies whether the entry applies to all IP addresses or just individual ones. If the user wishes to specify a specific IP address, then she will also have the option of specifying if it appears in the source, destination or either location within the UDP or TCP header.

The “All Ports” check box 263 allows the user to either specify a specific port number or specify all ports. If the user has specified all ports, the user will also be able to select if the port number appears in the source, destination or either location within the UDP or TCP header. The “Protocol” field specifies whether this entry applies to TCP, UDP or both types of IP packets.

In the Packet Disposition section 259, three outcomes are listed that can occur when a packet has been received. If the “Alternate” radio button 265 is selected, then when a packet arrives that matches the user selected properties, it will only be routed over the network specified in the “Network” drop down list box 267. If the “Default” radio button 269 is selected, then when a packet arrives which matches the user selected properties, it will be routed according to the default network configuration. Finally, if the “Ignore” radio button 271 is selected, then anytime a packet is analyzed that matches the user defined criteria, it will be ignored and an ICMP destination unreachable message will be sent back to the sender of the packet.

FIG. 18(a) is a screen shot presenting information from the default route table. The invention has a window that will display the active routes being used by the mobile application or device on the system. Since microprocessors store data in a binary format, the internal format of the route table will not be readable by humans. Therefore the invention allows a graphical user interface to be used to display the packets in a more meaningful presentation to the administrator.

FIG. 18(b) is a screen shot of an exemplary second “view” of the route table to display the non-active or alternate routes. When the “Primary” route table tab 273 is selected, the Primary route table will display any route that is active, such as shown in FIG. 18(a). When the “Alternate” route table tab 275 is selected, then the Alternate route table displays only routes that are inactive. In this screen the user has the option of clicking on either the “Primary” tab or the “Alternate”. The view will then be automatically updated to reflect the particular route table.

Prioritized Alternate Port Routing

The present invention enhances the aforementioned port routing system of the wireless mobile routing system. With prioritized alternate port routing, both the Host Network Server 20 and the Mobile Router 200 may route packets using a rule that specifies a priority order of multiple networks for each port of each IP address. With prioritized alternate port routing, both the Host Network Server 20 and the Mobile Router 200 may route packets for a single IP address or a specified, limited range of IP addresses maintained by the network administrator. Additionally, with prioritized alternate port routing, prioritized alternate port routing rules may be arranged in a port routing table, thereby providing an ability to create a routing rule for a range of IP addresses and exceptions to the routing rule for a subset of addresses in the range. The Mobile Router 200 will be able to ignore a packet for a single IP address or a specified, limited range of IP addresses according to an “Ignore” rule. The Mobile Router 200 will also be able to route packets according to a “Default” rule for a single IP address or a specified, limited range of IP addresses. Additionally, the Mobile Router 200 will also be able to route packets over an active default network specified in a master route table when no relevant entries are present in a port routing table.

Prioritized Alternate Port Routing Functionality and the Port Routing Table

The functional details of prioritized alternate port routing are now described. As discussed above, an aspect of the present invention includes the Port Routing Table 251. The Port Routing Table 251 stores entries to support the prioritized alternate port routing. In one embodiment, the table includes fields enabling administrators to specify port routing at a granularity that includes the protocol, a reference IP address, a range of IP addresses, a port number and a network. One embodiment of the Port Routing Table 251 includes eight different fields that contain specific routing information, including rule type, IP address, range of IP addresses, port number, protocol type, the prioritized networks, and two fields to specify source location and/or destination location for the port number and the IP address.

The above mentioned system supports the ability to provide bi-directional communications. The mobile routers 200 can send packets inbound to the host network and the applications residing on the host network can send packets outbound to the mobile routers 200. Because of this bi-directional nature, a port routing table 251 should exist on both the mobile routers 200 and the host network server 20. Therefore, regardless of which side initiates the transmission, the packet will travel over the correctly chosen network.

As in the Port Routing embodiments, in one embodiment of the Prioritized Alternate Port Routing, the Port Route Type field will contain an “Ignore”, “Alternate” or “Default” keyword. Each keyword specifies the routing behavior for a packet meeting user-defined criteria when the packet is received by the Mobile Router 200.

If a packet's characteristics match user defined criteria stored in the Port Routing Table 251 (e.g., IP address, port) and the corresponding Port Route Type field contains an “Alternate” network indicator value, then the packet will be sent through the specified highest priority alternate network that is available.

The IP Address field will identify at least one IP address associated with the packet received by the Mobile Router 200. The IP Address field can represent “All” IP addresses, or a specific IP address. If a specific IP address is entered, then the user has the choice of specifying that the rule applies only when the IP address appears in the source address, only when the IP address appears in the destination address, or when the IP address appears in either of the source or the destination address.

In an embodiment, a range of IP addresses subject to the rule is identified by a “Netmask” field. The specified range of IP addresses may be set with reference to the IP address identified in the IP Address field. For example, the IP Address field may specify a low address of the range, and the range may be specified by a Netmask field.

The Netmask field takes advantage of the standardized address protocols for IP addresses. On a TCP/IP network, an IP address has 32 bits, usually expressed as four decimal numbers separated by dots, where each decimal number represents eight address bits. Each decimal number ranges from 0 to 255. The IP addresses are assigned to networks and subnets in a hierarchy indicated by the address. Therefore, routers can address packets according to standardized rules rather than an extensive and ever-changing address book.

A netmask is used to “mask” a specified number of high order bits of an address by setting the masked bits, in series, to a value of “1”. For example, a netmask of 255.255.255.248 is used to indicate a mask of the first 29 bits. The Netmask field can be used to set a condition for low order bits in an IP address to specify that local communications within a range indicated by the netmask are subject to the rule.

The system administrator may specify a range of addresses for which a rule applies. An IP address and a netmask may both be specified for an entry of the Port Routing Table 251 to indicate that the rule applies to any IP address within the netmask range of the specified address. Accordingly, the Netmask field may be used to specify a range of IP addresses subject to a prioritized alternate routing rule.

The prioritized alternate port routing additionally allows a system administrator to specify networks and the priority order of the networks which should be used for routing application packets. The packet is routed over the highest priority order specified for an entry in the Port Routing Table 251.

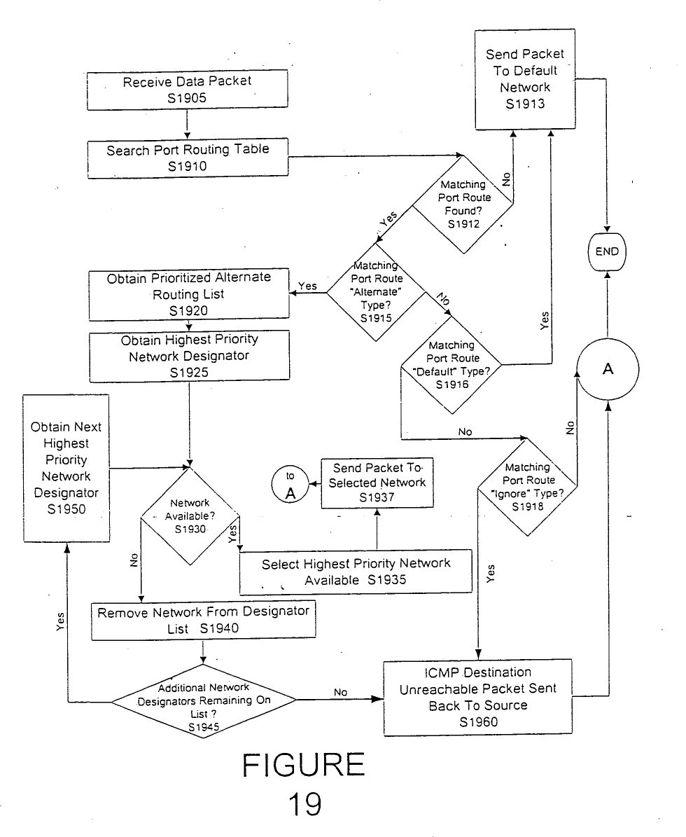

FIG. 19 shows a flow diagram depicting an exemplary manner of determining a prioritized alternate route and routing a packet using a Port Routing Table 251.

The process starts at step 1905 when a data packet is received. At S1910, the Port Routing Table is searched and at S1912 a determination is made whether a matching entry is found. If no matching entry is found in the Port Routing Table 251 (S1912=No), then the packet is sent to the default network at S1913 and the process ends. If a matching entry is found (S1912=Yes), then a determination is made at S1915 whether the entry is an “Alternate” entry. If the entry is not an “Alternate” entry of the Port Routing Table 251 (S1915=No), a determination is made at S1916 whether the entry is a “Default” entry. If the entry is a “Default” entry (S1916=Yes), the packet is sent to the default network at S1913 and the process ends. However, if the entry is not a “Default” entry (S1916=No), a determination is made at S1918 whether the entry is an “Ignore” entry. If the entry is an “Ignore” entry (S1918=Yes), the packet is discarded, an ICMP Destination Unreachable Packet is sent back to the source at S1960 and the process ends.

If the entry is an “Alternate” entry of the Port Routing Table 251 (S1915=Yes), a list of the prioritized alternate routes for the entry is retrieved at S1920. The list of the prioritized alternate routes may be obtained by, for example, copying the list from a memory that stores entries of the Port Routing Table 251.

The designator for the highest priority network in the list is obtained at S1925, and a determination whether the network is available is made at S1930. If the network is available (S1930=Yes), the network is selected at S1935. When the network is selected at S1935, the packet is sent to the selected network at S1937 and the process ends.

If the network is not available at S1930 (S1930=No), the network designator is removed from the retrieved list at S1940. The removal of the unavailable network entry is only performed on the temporary list copied from the memory. In another embodiment, rather than removing the network designator from the list at S1940, a pointer may be incremented to point to the next entry on the list.

A determination is made at S1945 whether another network designator remains on the list. If no additional network designators remain on the list (S1945=No), the packet is discarded, an ICMP Destination Unreachable Packet is sent back to the source at S1960 and the process ends.

If additional network designators remain on the copied list (S1945=Yes), the next highest network designator is retrieved at S1950 and the determination of network availability repeats at S1930. The process of determining a prioritized alternate route and routing a packet ends when the packet is sent to a network at S1913 or S1937, or when the packet is discarded and an ICMP Destination Unreachable Packet is sent back to the source at S1960. Additionally, the process ends when a matching port route is found at S1912 but no matching “Alternate”, “Default” or “Ignore” rules are found at S1915, S1916 and S1918 respectively.

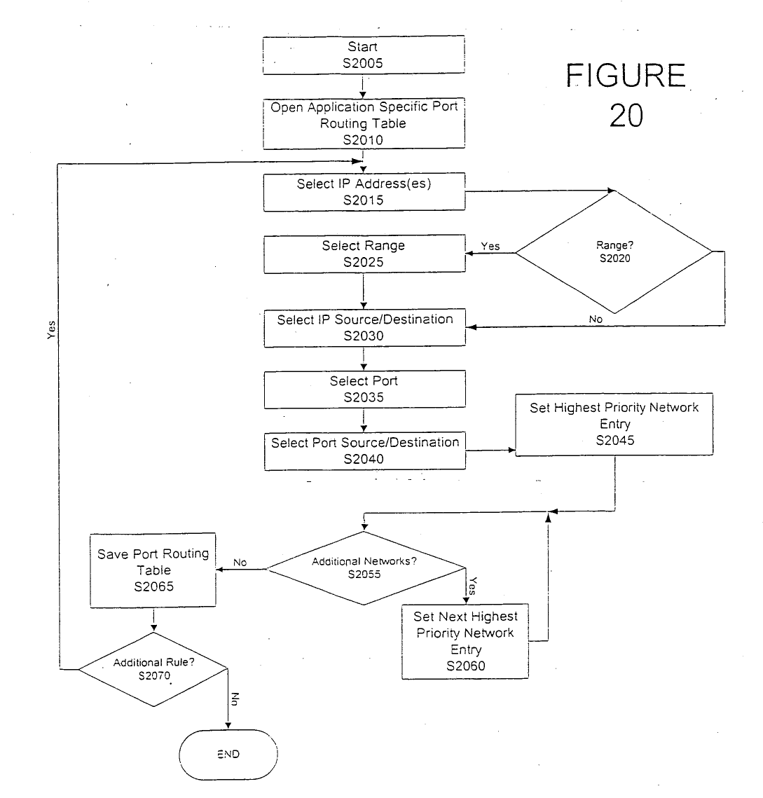

FIG. 20 is a flow diagram that depicts an exemplary manner in which prioritized alternate routes are added to a port routing table. The process starts at S2005 and the Port Routing Table is opened at S2010. At S2015, the IP address is selected. A determination is made whether the rule will apply to a range of IP addresses at S2020. If the rule will apply to a range of IP addresses (S2020=Yes), the range is selected at S2025, using, for example, a netmask. If the rule will not apply to a range of IP addresses (S2020=No), or once the range has been selected at S2025, the administrator selects whether the rule will apply to the source of a packet, the destination of a packet, or either the source or the destination of a packet at S2030. Additionally, the administrator may specify that the rule applies only when both the source and the destination are within a specified address range. The administrator selects the port that the rule applies to at S2035. The administrator selects whether the information of the specified port is located in the source of a packet, the destination of a packet, or either the source or the destination of a packet at S2040.

At S2045, the highest priority network entry is set. At S2055, a determination is made whether additional networks are to be set under the prioritized alternate port routing rule. If additional networks are to be set (S2055=Yes), the next highest priority network is set at S2060. If additional networks are not to be set under the prioritized alternate port routing rule (S2055=No), the Port Routing Table 251 is saved at S2065. A determination is made at S2070 whether additional rules are to be entered. If additional rules are not to be entered (S2070=No), the process ends. However, if additional rules are to be entered (S2070=Yes), the process returns to S2015 so that an IP address can be selected.

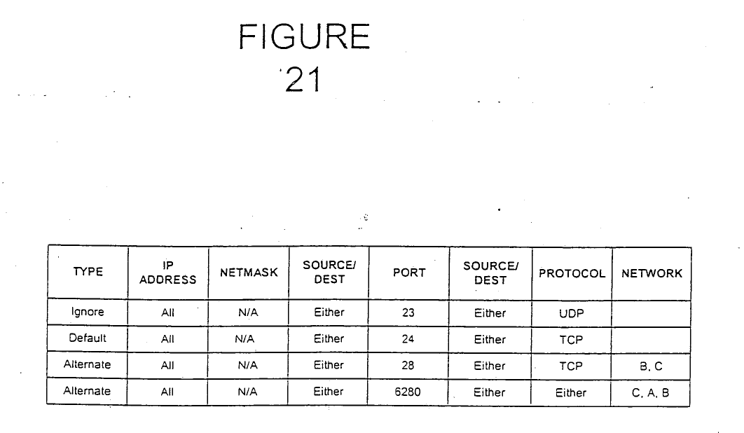

FIG. 21 is an exemplary enhanced Port Routing Table 251. The Port Routing Table 251 shown in FIG. 21 specifies port-specific routing priorities that may override any Default routing set for the system. Accordingly, if the system administrator has specified that Network A is the current primary Default network in the master route table, the Port Routing Table 251 can be used to attempt to route packets to or from port 28 over Network B, and then over Network C before Network A. Additionally, the system administrator may specify that Network A is not to be used to route a packet for a particular port.

In the example of FIG. 21, the first entry shows an “Ignore” rule for UDP protocol packets routed to or from port 23 of any IP address. The prioritized alternate port routing allows an administrator to specify that “All” IP addresses are subject to a rule for a particular port. Additionally, the second entry shows a “Default” rule for TCP protocol packets routed to or from port 24 of any IP address. No entry is added to the Network ID field for either “Ignore” or “Default” rules because “Ignore” rules specify that a packet will not be routed, and because the “Default” route depends on the highest priority available network specified in the master route table.

The third entry in Port Routing Table 251 of FIG. 21 has an “Alternate” type. The third entry specifies that for TCP protocol packets routed to or from port 28 of all IP addresses maintained by the administrator, Network B is the first (highest) priority route and Network C is the second (second highest) priority route. Accordingly, if Network B is not available for packets routed to or from port 28 of any IP address, the Port Routing Table 251 of FIG. 21 specifies that Network C is to be used. Additionally, no other network is specified, so if Network B and Network C are not available, then the packet is discarded and an ICMP Destination Unreachable Packet may be sent back to the packet source.

FIG. 21 also shows a fourth entry that specifies that packets of any type to or from port 6280 are to be routed to network C if available. If network C is not available, the rule specifies that the packet will be routed over network A. If network A is not available, the rule specifies that that packet will be routed over network B.

The rules for each of the entries of the Port Routing Table 251 in FIG. 21 apply to specified ports of all IP addresses, rather than a specific range of addresses set by the Administrator. Accordingly, each of the entries of the Port Routing Table 251 in FIG. 21 have “N/A” entered in the Netmask field. Additionally, each of the entries shown in FIG. 21 applies to a different port. Accordingly, only a single rule applies to any given port according to the Port Routing Table 251 shown in FIG. 21. However, an administrator has the ability to specify a range and an order of rule application using prioritized alternate port routing.

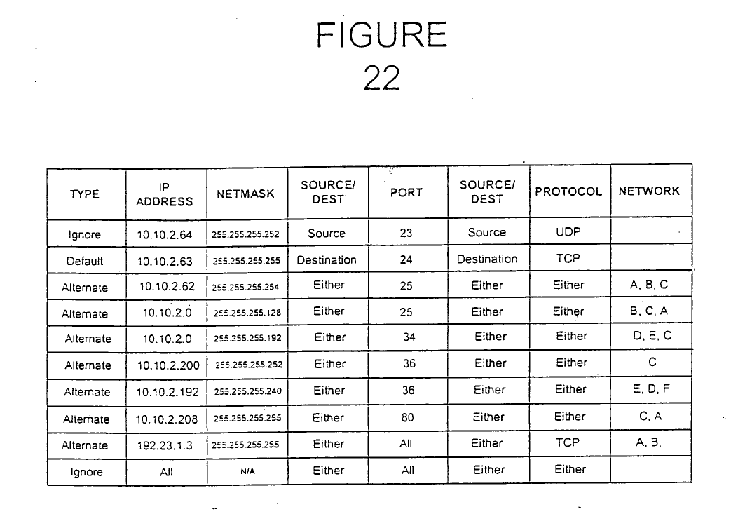

FIG. 22 is another exemplary enhanced Port Routing Table 251. In the exemplary Port Routing Table 251 of FIG. 22, the Source/Destination fields have entries of, e.g., “Source”, “Destination”, “Either” and “Both” to specify criteria for a particular rule. Additionally, the Protocol field has entries of, e.g., “UDP”, “TCP”, “Either” and “Both”. Packets that meet each criteria of a specified rule are routed according to the rule.

In the example of FIG. 22, the first entry specifies an “Ignore” rule. UDP packets from port 23 of IP Address 10.10.2.64 are ignored according to the rule of the first entry. Additionally, the Netmask field for the first entry has been specified as 255.255.255.252, which corresponds to a range (variability) of 4. Accordingly, UDP packets from port 23 of any IP address in the range 10.10.2.64 through 10.10.2.67 are ignored. As shown, the rule of the first entry only applies to packets from the specified port in the specified address range.

The second entry of Port Routing Table 251 in FIG. 22 specifies a “Default” rule. TCP packets to port 24 for IP address 10.10.2.63 are routed according to the rule of the second entry. Additionally, the Netmask field for the second entry has been specified as 255.255.255.255, which corresponds to a range (variability) of 1. Accordingly, TCP packets to port 24 of only IP Address 10.10.2.63 are routed by the default network using the rule of the second entry. As should be clear from the rules of the first and second entries in FIG. 22, the Netmask field can be used to specify a range of IP addresses for routing rules of a Port Routing Table.

In the example of FIG. 22, the netmask information for the first entry specifies that the rule applies to the four IP addresses beginning 10.10.2.64. In other words if the first decimal, the second decimal, the third decimal, and the first six bits (2⁷+2⁶+2⁵+2⁴+2³+2²) of the fourth decimal of the IP address are the same as the specified address of 10.10.2.64, then the “Ignore” rule specified for port 23 in the first entry applies. Specifically, the netmask and IP address combination specifies that any of the 4 addresses in the IP address range starting at 10.10.2.64 are subject to the “Ignore” rule. Additionally, the netmask information for the second entry specifies that the rule applies to only the one IP address beginning 10.10.2.63. Accordingly, the “Default” rule specified for port 24 in the second entry only applies to packets to the IP address specified in the IP Address field.

The third entry of the Port Routing Table 251 of FIG. 22 specifies prioritized alternate routing for packets to or from port 25 of the IP addresses within the range beginning 10.10.2.62 and ending 10.10.2.63. In the example of the third entry in FIG. 22, the highest priority routing network is network A and, if network A is not available, the second highest priority routing network is network B. If networks A and B are not available, the third entry specifies that the packet should be routed over network C.

Additionally, the fourth entry of the Port Routing Table 251 of FIG. 22 specifies the prioritized alternate port routing for packets to or from port 25 of the specified IP addresses 10.10.2.0 through 10.10.2.127. The prioritized alternate port routing for the range of specified addresses uses network B as the highest priority routing network and, if network B is not available, the second highest priority routing network is network C. The prioritized alternate port routing for the fourth entry specifies that, if networks B and C are not available, then network A should be used.

In an embodiment a particular port of a particular IP address may be associated with multiple port routing rules. For example, an IP address may be subject to one prioritized alternate port routing rule specific to the IP address itself, and may also be subject to a second prioritized alternate port routing rule because the IP address itself is included within a range of IP addresses subject to the second rule. In an embodiment, each packet is subject to processing under only one rule, even when none of the networks specified by the rule are available. Because the placement of the rules governs which rule is applied to the packet, the administrator may arrange the rules so that a packet corresponding to a particular IP address is only subject to a particular rule.

The range of IP addresses for the rule of the third entry for port 25 overlaps with a portion of the range of the rule of the fourth entry for port 25. Accordingly, both rules apply to packets to or from port 25 of IP addresses 10.10.2.62 and 10.10.2.63. However, in the embodiment of FIG. 22, the table is searched at S1910 from top to bottom. Accordingly, packets to or from port 25 of IP addresses 10.10.2.62-10.10.2.63 are subject to the rule of the third entry. In particular, the third entry is matched with the packet before the fourth entry is compared. Accordingly, the rule of the third entry is used to route packets to or from port 25 of IP addresses 10.10.2.62-10.10.2.63. In this regard, the rule of the third entry is an exception to the rule of the fourth entry because the rule of the fourth entry would be used to route the packets in a manner different from the rule of the third entry.

The Port Routing Table may have a first rule that applies to a broad range of IP addresses and a second exception rule that applies to a narrower band within the range of the IP addresses. Additionally, a third rule may be an exception to the second rule. However, in the embodiment of FIG. 22, the packets are routed according to only one rule of the Port Routing Table 251. Accordingly, if none of the networks specified in a rule are available, then the packet is discarded and an ICMP Destination Unreachable Packet is sent back to the source at S1960 without determining whether another prioritized alternate routing rule applies to the packet.

The fifth entry of the Port Routing Table 251 of FIG. 22 specifies the prioritized alternate port routing for packets to or from port 34. In particular, the fifth entry specifies that packets routed to or from port 34 of the IP addresses 10.10.2.0 through 10.10.2.63 will use network D as the highest priority routing network and, if network D is not available, the second highest priority routing network is network E. The prioritized alternate port routing for the fifth entry specifies that, if networks D and E are not available, then network C should be used. Of course, if the administrator wishes to make an exception to the rule of the fifth entry, the exception rule would be placed above the fifth entry in the embodiment of FIG. 22.

The sixth entry of the Port Routing Table 251 shown in FIG. 22 specifies that packets routed to or from port 36 of IP addresses in the range 10.10.2.200 through 10.10.2.203 will be routed to network C, if available. If network C is not available, the packet is discarded and an ICMP Destination Unreachable Packet is sent back to the source at S1960 because no other networks are specified.

The seventh entry of the Port Routing Table 251 shown in FIG. 22 specifies that packets routed to or from port 36 of IP addresses in the range 10.10.2.192 through 10.10.2.207 are routed over Network E if Network E is available. If Network E is not available, the packets are routed over network D. If networks E and D are not available, the packets are routed over network F.

The addresses of the rule of the sixth entry in FIG. 22 are within the range of the rule of the seventh entry. Accordingly, the rule of the sixth entry is an exception to the rule of the seventh entry in FIG. 22. Packets to or from port 36 of IP addresses 10.10.2.200-203 are subject to the rule of the sixth entry while packets to or from IP addresses 10.10.2.192-199 and 10.10.2.204-207 are routed according to the rule of the seventh entry.

The eighth entry of the Port Routing Table 251 in FIG. 22 specifies that packets to or from port 80 of IP address 10.10.2.208 are to be routed over network C if available. If network C is not available, the packets are routed over network A. If networks C and A are not available, the packet is discarded and an ICMP Destination Unreachable Packet is sent back to the source.

The ninth entry of the Port Routing Table 251 in FIG. 22 specifies that packets to or from any port of IP address 192.23.1.3 are to be routed over network A if available. If network A is not available, the packet is routed over network B. If networks A and B are not available, the packet is discarded and an ICMP Destination Unreachable Packet is sent back to the source.

The tenth entry of the Port Routing Table 251 in FIG. 22 is a global “Ignore” rule that applies to any port and any IP address where a rule is not otherwise specified. Accordingly, a network administrator may specify that if a rule does not specifically apply to a packet, then the packet is to be ignored. In this regard, each of the rules of the first through ninth entries is an exception to the rule of the tenth entry in FIG. 22, insofar as the tenth rule would apply if any of the first nine did not. Additionally, the global rule may be used to guarantee that a matching port route is found for every packet at S1912. Accordingly, the only way in which a packet is sent over the “Default” network specified in the master route table is if the packet matches a “Default” type rule in the Port Routing Table 251.

As can be seen in the enhanced Port Routing Tables 251 of FIGS. 21-22, port routing may be specified for each port of each address using prioritized alternate port routing. For example, a configuration can be used to allow email applications for a specific IP address to function over only a single specified network. The configuration may specify that a computer aided dispatching application packet for a range of IP addresses is routed over a second network and, if the second network is not available, the computer aided dispatching application packets are routed over a third network. The configuration may specify that the computer aided dispatching application is never routed over the first network. Additionally, the configuration of the Port Routing Table 251 may specify an exception to a rule according to the placement of related rules in the table.

Additionally, prioritized alternate port routing instructions may be provided for a range of IP addresses using, for example, a “Netmask” instruction. The netmask instruction may be used to specify identical alternate routing with a single instruction for a range of IP addresses. Of course, an administrator may also specify that all IP addresses are subject to a specific rule. Additionally, an administrator may specify that a single IP address is subject to a specific routing rule. At the finest granularity, the Prioritized Alternate Port Routing functionality can be used to specify the routing priority of multiple networks for a single port of a single IP address. Additionally, using the netmask entry, rules for a range of IP addresses can be set for an entire local network (i.e., subnetwork).

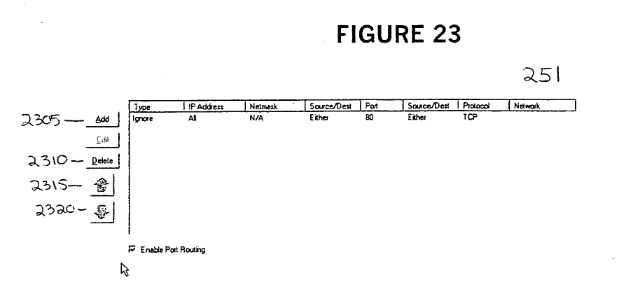

FIG. 23 is an exemplary screen shot that shows an enhanced Port Routing Table 251 with buttons that allow a system administrator to add, delete or change the placement of rules. In this example, the system administrator can add or delete prioritized alternate port routing rules. The system administrator can start to add a rule by clicking the Add Button 2305. The system administrator can also highlight an existing rule and delete the rule by clicking the Delete Button 2310. Additionally, the system administrator can highlight an existing rule and change the placement of the rule in the Port Routing Table 251 by clicking the Up Arrow button 2315 or Down Arrow button 2320.

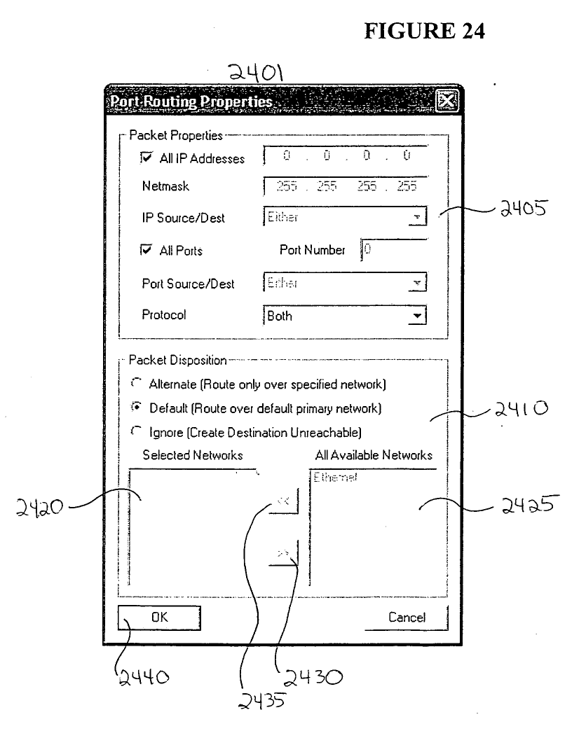

FIG. 24 is an exemplary screen shot that shows an enhanced Port Routing Properties Screen 2401 that allows the system administrator to add a rule to the Port Routing Table 251. The screen appears when the user clicks the Add Button 2305 from the Port Routing Table 251, as depicted in FIG. 23.

The configuration window is separated into two sections. In the Packet Properties section (2405, top half), the administrator is able to specify the actual packet criteria to which the specific prioritized alternate port routing rule should be applied. In the Packet Disposition section (2410, bottom half), the administrator will be able to specify the routing of the packet that the rule describes.

The Packet Properties section 2405 includes a Netmask Entry field for entering a netmask for a specified IP address. With the Netmask Entry field, the administrator will be able to specify a range of IP addresses to which the specific prioritized alternate port routing rule should be applied. An IP Addresses field is provided for entering the specified IP address. The Packet Properties section 2405 includes an IP Source/Destination field for specifying whether the rule applies to packets from the specified IP addresses, packets to the specified IP addresses, or packets either to or from the specified IP address.

A Port Number field is also provided in the Packet Properties section 2405 for entering the port number to which the specific prioritized alternate port routing rule should be applied. A Port Source/Destination is included for specifying whether the rule applies to packets from the specified port, packets to the specified port, or packets either to or from the specified port. Additionally, a Protocol field is included for specifying whether the rule applies to packets using a particular protocol.

The Packet Disposition section 2410 shows the action to take once a packet is received. The packet disposition section 2410 includes a Selected Networks field 2420, an All Available Networks field 2425, a Right Arrow button 2430 and a Left Arrow button 2435. The Selected Networks field 2420, the All Available Networks field 2425, the Right Arrow button 2430 and the Left Arrow button 2435 are only used when an Alternate Route packet disposition is selected. Networks listed in the All Available Networks field 2425 can be moved to the Selected Networks field by highlighting an available network and clicking the Left Arrow button 2435. The prioritized alternate routing list is created in the order in which networks are moved from the All Available Networks field 2425 to the Selected Networks field 2420. The prioritized alternate routing list can also be edited by moving a selected network from the Selected Networks field 2420 to the All Available Networks field 2425 by highlighting a network in the prioritized alternate routing list and clicking the Right Arrow button 2430. When the prioritized alternate routing list is arranged according to the criteria of the system administrator, the system administrator clicks an OK button 2440 to save the prioritized alternate routing rule and enter the rule in the Port Routing Table 251.

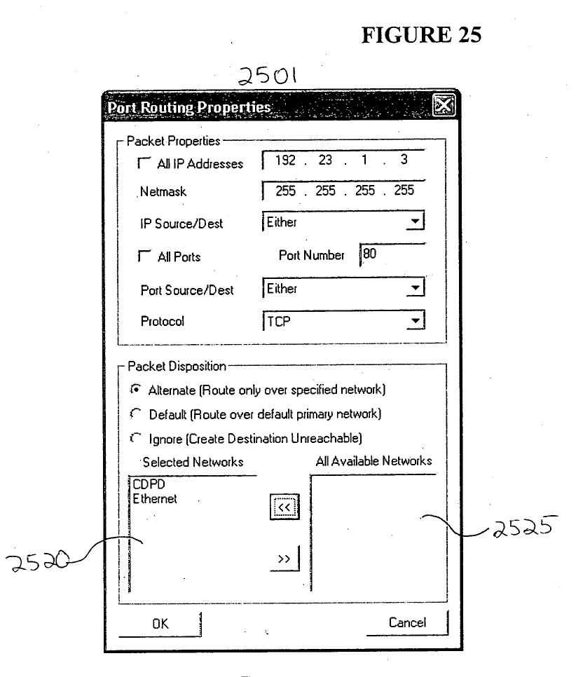

FIG. 25 is a screen shot of an exemplary populated enhanced Port Routing Properties Screen 2501. The Port Routing Properties Screen 2501 is used to create an prioritized alternate port routing rule. In the screen shot of FIG. 25, the system administrator has arranged the CDPD network as the highest priority network in the Selected Networks field 2520 for port 80 of the specified IP address. The system administrator has arranged the Ethernet network as the second highest priority network for port 80 of the specified IP address. Additionally, no networks remain in the All Available Networks 2525, so the rule being created in FIG. 25 will only include the two networks. The Port Source/Destination field specifies that packets “Either” routed to or from the specified port are subject to the rule being created. Additionally, the Protocol field specifies that the rule applies to TCP packets.

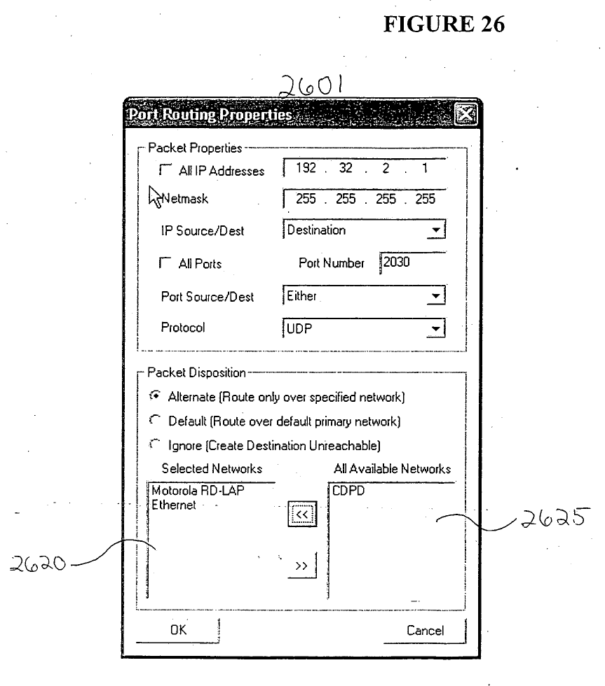

FIG. 26 is a screen shot of another exemplary enhanced Port Routing Properties Screen 2601. The Port Routing Properties Screen 2601 is used to create a prioritized alternate port routing rule. In the screen shot of FIG. 26, the system administrator has arranged the Motorola RD-LAP network as the highest priority network in the Selected Networks field 2620 for port 2030 of the specified IP address. The system administrator has arranged the Ethernet network as the second highest priority network for port 2030 of the specified IP address. Additionally, because the CDPD network remains in the All Available Networks 2625, the CDPD network will not be used for communication and the system rule being created in FIG. 26 will include only the two networks in the Selected Networks field 2620. The Port Source/Destination field specifies that packets “Either” routed to or from the specified port are subject to the rule being created. Additionally, the Protocol field specifies that the rule applies to UDP packets.

Accordingly, the system administrator can create a rule for a port of a specific IP address or a range of IP addresses with a Port Routing Properties Screen 2401, 2501 or 2601 of FIGS. 24-26. As shown in FIGS. 21-22 and 25-26, the prioritized alternate routing rules may specify a prioritized order in which packets are to be routed over available networks. The rules can be arranged in a desired position of the Port Routing Table 251 of FIG. 23 with the Up Arrow button 2315 or Down Arrow button 2320. The system administrator can create a first rule that is an exception to another rule by placing the first rule in a portion of the Port Routing Table 251 where the first rule will be matched with a packet before the second rule is matched at S1912 in FIG. 19. Additionally, the system administrator can create a global disposition rule, as shown in FIG. 22, so that each of the other rules is an exception to the global disposition rule. Additional exceptions may be specified in the Port Routing Table 251, as shown in the exemplary third and sixth entries in FIG. 22.

The system administrator can create prioritized alternate routing rules according to the flow diagram shown in FIG. 20, or according to any other process for specifying a port, a range of IP addresses, a rule type, and/or a prioritized alternate routing list. The prioritized alternate routing rules may also specify that only packets that are from a port and/or address, to a port and/or address, or either to or from a port and/or address type, will be routed according to a particular prioritized alternate routing rule. Additionally, the prioritized alternate routing rule may specify that only packets corresponding to a particular protocol, e.g., TCP or UDP, will be disposed of according to the rule. Accordingly, the prioritized alternate port routing functionality provides an ability to specify prioritized alternate port routing for a packet at a granularity that includes the protocol, IP address or multiple IP addresses, port number, and the specific networks over which any packet matching the IP address, protocol and port number should be routed according to the specified prioritization.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims. For example, although the embodiments described above generally refer to routing over wireless networks from the Mobile Router 200, the present invention also operates when sending data from the Host Network Server 20. In this case, the Host Network Server 20 determines network availability based on information received from the Mobile Routers 200, in contrast to when the Mobile Router 200 is routing data and determining network availability for itself.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet-switched network transmission (e.g., IP, TCP/IP, UDP/IP) represent examples of the state of the art. Such standards are periodically superseded by faster or more efficient equivalents having essentially the same functions. Accordingly, replacement standards and protocols having the same functions are considered equivalents.

What is claimed:

1. A method for routing data for an application over a highest priority, available network selected from a plurality of networks that are assigned application-specific routing priorities, the method comprising:
receiving data of the application;
determining the highest priority network for the application based on the assigned application-specific priorities;
sending the received data over the highest priority network when the highest priority network is available and, when the highest priority network is unavailable, determining a next highest priority network for the application based on the assigned application-specific priorities; and
sending the received data over the next highest priority network when the next highest priority network is available.

2. The method of claim 1, in which each of the plurality of networks is a wireless network.

3. The method of claim 1, in which the determining the highest priority network and the determining the next highest priority network are based upon at least one port number associated with the received data.

4. The method of claim 1, in which the determining the highest priority network and the determining the next highest priority network are based upon at least one IP address associated with the received data.

5. The method of claim 1, in which the determining the highest priority network and the determining the next highest priority network are based upon at least one protocol of the received data.

6. The method of claim 1, further comprising storing a different priority for the highest priority network and the next highest priority network as a rule in a memory.

7. The method of claim 6, further comprising applying the rule to a plurality of IP addresses.

8. The method of claim 6, further comprising subjecting the received data to the rule and ignoring, based upon a predetermined order for subjecting received data to a plurality of rules, another rule for routing data for the application.

9. A system for routing data for an application over a highest priority, available network selected from a plurality of networks that are assigned application-specific routing priorities, the system comprising:
a mobile router that receives data of the application, the mobile router comprising a port routing table containing information that specifies, based on the assigned application-specific priorities, the highest priority network for the application and a next highest priority network for the application, the mobile router sending the received data over the highest priority network when the highest priority network is available and, when the highest priority network is unavailable, the mobile router sending the received data over the next highest priority network when the next highest priority network is available.

10. The system of claim 9, wherein each of the plurality of networks is a wireless network.

11. The system of claim 9, wherein the information is at least one port number associated with the received data.

12. The system of claim 9, wherein the information is at least one IP address associated with the received data.

13. The system of claim 9, wherein the information is at least one protocol of the received data.

14. The system of claim 9, wherein the port routing table contains the information as a rule specifying a different priority for the highest priority network and the next highest priority network.

15. The system of claim 14, wherein the rule specifies the priority for the highest priority network and the next highest priority network for a plurality of IP addresses.

16. The system of claim 14, wherein the received data is subject to the rule and, based upon a predetermined order for subjecting received data to a plurality of rules, another rule for routing data for the application is ignored.

17. A system for routing data for an application over a highest priority, available network from a plurality of networks that are assigned application-specific routing priorities, the system comprising:
a host network server that receives data of the application, the host network server comprising a port routing table containing information that specifies, based on the assigned application-specific priorities, the highest priority network for the application and a next highest priority network for the application, the host network server sending the received data over the highest priority network when the highest priority network is available and, when the highest priority network is unavailable, the mobile router sending the received data over the next highest priority network when the next highest priority network is available.

18. A computer readable medium storing a computer program that enables the specification of routing behavior for an application over a highest priority, available network from a plurality of networks that are assigned application-specific routing priorities, the medium comprising:
a source code segment that receives data of the application;
a port routing table containing information that specifies, based on the assigned application-specific routing priorities for the application, the highest priority network for the application and a next highest priority network for the application; and
a source code segment that sends the received data over the highest priority network when the highest priority network is available and, when the highest priority network is unavailable, that sends the received data over the next highest priority network when the next highest priority network is available.

19. The medium of claim 18, wherein each of the plurality of networks is a wireless network.

20. The medium of claim 18, wherein the port routing table comprises at least one of a port route type indicator field, an IP address field, a netmask field, a protocol type field, a port number field, and a network ID field.

21. The medium of claim 20, wherein the network ID field comprises a designator for each of the plurality of networks and an assigned priority for each of the plurality of networks.

22. The medium of claim 18, wherein the information comprises a rule specifying a different priority for the highest priority network and the next highest priority network.

23. The medium of claim 22, wherein the rule specifies the routing priorities for a plurality of IP addresses.

24. The medium of claim 22, wherein the received data is subject to the rule and, based upon a predetermined order for subjecting received data to a plurality of rules, another rule for routing data for the application is ignored.

25. The medium of claim 18, wherein the information is one of a port number associated with the received data, an IP address associated with the received data and a protocol of the received data.

26. The medium of claim 18, further comprising an availability source code segment that ascertains the availability of the plurality of networks.
